(19) United States
(12) Patent Application Publication
(10) Pub. No.: US 2022/0144422 A1
(43) Pub. Date: May 12, 2022

(54) Modular Device For Propulsion In A Vehicle

(71) Applicant: Hugh Bryan Welcel, Winter Park, FL (US)

(72) Inventor: Hugh Bryan Welcel, Winter Park, FL (US)

(21) Appl. No.: 17/510,017

(22) Filed: Oct. 25, 2021

Related U.S. Application Data
(60) Provisional application No. 63/105,513, filed on Oct. 26, 2020.
(60) Provisional application No. 63/105,513, filed on Oct. 26, 2020.
(60) Provisional application No. 63/160,052, filed on Mar. 12, 2021.
(60) Provisional application No. 63/163,834, filed on Mar. 20, 2021.
(60) Provisional application No. 63/184,300, filed on May 5, 2021.
(60) Provisional application No. 63/185,025, filed on May 6, 2021.
(60) Provisional application No. 63/191,390, filed on May 21, 2021.
(60) Provisional application No. 63/218,876, filed on Jul. 6, 2021.
(60) Provisional application No. 63/224,375, filed on Jul. 21, 2021.
(60) Provisional application No. 63/224,371, filed on Jul. 21, 2021.
(60) Provisional application No. 63/224,365, filed on Jul. 21, 2021.
(60) Provisional application No. 63/224,628, filed on Jul. 22, 2021.
(60) Provisional application No. 63/225,613, filed on Jul. 26, 2021.
(60) Provisional application No. 63/235,841, filed on Aug. 23, 2021.
(60) Provisional application No. 63/241,073, filed on Sep. 6, 2021.

(51) Int. Cl. B64C 29/00; B64C 15/02; F02K 1/00; F02K 3/02; B64D 33/04

(52) U.S. Cl. CPC B64C 29/0066; B64C 15/02; F05D 2220/323; F02K 3/025; B64D 33/04; F02K 1/006

(57) ABSTRACT

The present disclosure provides a device for propulsion in a vehicle. The device comprises an inlet for allowing a fluid, a power module provided for accelerating the fluid, a vector thrust mechanism fluidly connected to the power module for redirecting the accelerated fluid to a predetermined angle and the vector thrust mechanism redirecting the fluid towards an exhaust provided at a predetermined direction for generating the thrust in the predetermined direction to maneuver the vehicle.

The present application claims priority from the following provisional applications bearing provisional application No. 63/105,513, 63160052, 63163834, 63184300, 63185025, 63191390, 63218876, 63224375, 63224371, 63224365, 63224628, 63225613, 63235841 and 63241073.

### FIELD

The embodiments herein generally relate to an electric propulsion vectored system for a vehicle for adding different maneuvers capabilities to the vehicle. More particularly, the disclosure relates to an electric propulsion vectored system of modular design for the development of vertical take-off and landing or short take-off and landing (VTOL/STOL) capable flying vehicles.

### BACKGROUND AND PRIOR ART

A propulsion system is the most important part of a vehicle. The propulsion system is the thrust generator for moving the vehicle in a specific direction. Many kinds of propulsion systems have been designed and its design, energy source, mechanisms, specifications vary according to the type of vehicle in which it will be used.

Currently, green energy sources, being environmentally friendly, are a preferred source of energy for the development of any type of vehicle. Electrical energy is the source with the greatest adaptation among users and developers, which also includes generation of electrical energy through processing of elements like hydrogen for charging a battery system or supplying direct energy to electrical motors or/and other devices.

For the development of flying vehicles, thrust is usually generated through the application of Newton's third law of action and reaction where a working fluid, is accelerated and the reaction to this acceleration produces a resulting force that is used to move the vehicle. There are many ways to accelerate a working fluid, the most used devices used in this field to accomplish with this task are the combustion engines or electric motors through a wide variety of processes and mechanisms transform an energy source into a pushing force. The resulting force generates a reaction of the acceleration of a working fluid that can be redirected in any desire direction with the use of a mechanism. The mechanisms that redirect the working fluid and the resulting force from one direction to another as required, are called vectored thrust mechanism.

Presently, the propulsion system technology has become more efficient, with the introduction of stronger and lighter materials, additive manufacturing process, computer controller systems, the use of electric power sources and other alternative energy sources. These advancements have enabled feasibility of the development of VTOL/STOL vehicles for usage not only for military purposes also for commercial purposes.

There are various propulsion systems with VTOL/STOL capabilities developed in the early years, but there are hardly few aircraft still flying that use a jet flow with a vector thrust mechanism such as the F35 lighting and the harrier jump jet, when there are mechanisms that have been already developed for this purpose. These above-mentioned aircraft together with other developed in early days like the BELL D-188A, the YAKOVLEV YAK-38, XFV-12 and others have demonstrated that an accelerated working fluid can be redirected through vector thrust mechanism to provide vertical flight capabilities to vehicles, where this mechanism can be designed in multiple ways. However, these propulsion systems required rotating or tilting the entire vehicle and engine, thereby necessitating in complex structures and mechanisms.

Therefore, there is a need for an improved and advanced propulsion system with a vector thrust mechanism. Moreover, there is a need for a propulsion system of modular design provided with vector thrust mechanisms for imparting VTOL/STOL capabilities to a vehicle with better efficiency.

### Objects

Some of the objects of the present disclosure are described herein below:

The main objective of the present disclosure is to provide a device for propulsion in a vehicle for providing vertical take-off and landing and short take-off and landing capabilities to the vehicle.

Another objective of the present disclosure is to provide an attachable and detachable device in a vehicle for propulsion.

Still another objective of the present disclosure is to provide a modular device for propulsion in vehicle for effective maneuvering of the vehicle in each flight stage.

Yet another objective of the present disclosure is to provide a customizable device for propulsion in a vehicle for customized generation of thrust and maneuvering of the vehicle.

The other objectives and advantages of the present disclosure will be apparent from the following description when read in conjunction with the accompanying drawings, which are incorporated for illustration of preferred embodiments of the present disclosure and are not intended to limit the scope thereof.

### SUMMARY

In view of the foregoing, an embodiment herein provides a device for propulsion in a vehicle.

In accordance with an embodiment, the device comprises an inlet for allowing a fluid, a power module provided for accelerating the fluid, a vector thrust mechanism fluidly connected to the power module for redirecting the accelerated fluid to a predetermined angle and the vector thrust mechanism redirecting the fluid towards an exhaust provided at a predetermined direction for generating the thrust in the predetermined direction to maneuver the vehicle.

In an embodiment, an exhaust module fluidly connected to the vector thrust mechanism for letting out the fluid and the exhaust module including a plurality of exhausts provided in a plurality of directions for generating the thrust in the predetermined direction. In an embodiment, the vector thrust mechanism providing vertical takeoff and landing capability and short takeoff and landing capability to the vehicle.

In accordance with an embodiment, the vector thrust mechanism including a ventral flap and the ventral flap rotating for opening and closing the exhaust of the device for generating the thrust in the direction of the open exhaust. In an embodiment, the vector thrust mechanism including turning vanes for correcting direction of the fluid for flowing through the exhaust. In an embodiment, a geometry of the ventral flap reducing loss of thrust and turbulence of the fluid and the geometry preventing leakage of the fluid to the closed exhaust. In an embodiment, the ventral flap adapted to geometry of the vehicle for contributing to lift production of a wing of the vehicle. In an embodiment, the ventral flap rotating about a shaft and connected to a rotating mechanism selected from a group consisting of servo motor, actuator and electric motor.

In accordance with an embodiment, the vector thrust mechanism including an external vectoring flap mechanism for redirecting the accelerated fluid and the external vectoring flap mechanism including plurality of ventral flaps rotatable for opening and closing the exhaust and redirecting the fluid to the predetermined direction for generating the thrust. In an embodiment, the rotation of the ventral flaps synchronized for opening an exhaust and closing another exhaust. In an embodiment, a rotating mechanism rotating the ventral flaps and the rotating mechanism selected from a group consisting of servo motor, actuator and electric motor.

In accordance with an embodiment, the vector thrust mechanism including a bucket mechanism for redirecting the accelerated fluid and the bucket mechanism including a curved surface retracting and expanding about an angle relative to a point of contact to the device for redirecting the fluid to the predetermined direction. In an embodiment, a rotating mechanism rotating the curved surface and the rotating mechanism selected from a group consisting of servo motor, actuator and electric motor. In an embodiment, the curved surface including plurality of segments forming a foldable bucket mechanism for reducing occupation of space in the device and the segments foldable during retraction and expanded during expansion of the curved surface.

In accordance with an embodiment, the vector thrust mechanism including a multi directional duct for redirecting the accelerated fluid and the multi directional duct including a rotating mechanism retracting and expanding to the predetermined angle for redirecting the fluid to the predetermined direction. In an embodiment, the rotating mechanism including gimbal rings providing a three bearing rotating swivel mechanism for changing an angle of the exhaust.

In accordance with an embodiment, the vector thrust mechanism including a cascade vanes mechanism for redirecting the accelerated fluid; and the cascade vanes mechanism including a plurality of spaced segments formed on a surface of the device, wherein the spaced segments movable relative to the device for opening and closing the exhausts.

In an embodiment, a secondary mechanism connected to the spaced segments for opening and closing the exhausts on surface of the device. In an embodiment, the segments are aligned through a frame ring provided as pivot for rotating the segments thereby opening and closing a horizontal exhaust of the device. In an embodiment, the segments and the secondary mechanism connected to a mechanism selected from a group consisting of servo motor, actuator and link for automated movement.

In accordance with an embodiment, the vector thrust mechanism including a rotating mechanism including a swivel elbow exhaust for redirecting the accelerated fluid, wherein the swivel elbow exhaust operatively connected to the power module through an exhaust duct for receiving the accelerated fluid and the swivel elbow exhaust rotatable relative to the power module about an angle ranging from 0 degrees to 360 degrees for redirecting the accelerated fluid.

In accordance with an embodiment, the vector thrust mechanism including a ventral curved surface rotatable by rotary servo and a shaft for opening and closing the exhaust and redirecting the fluid and the ventral curved surface redirecting the fluid to the predetermined direction with reduced turbulence.

In accordance with an embodiment, a case provided for housing the power module, the vector thrust mechanism and the exhausts and the case facilitating attachment and detachment of the device to the vehicle.

In accordance with an embodiment, the power module, the exhaust and the vector thrust mechanism integrated forming a vector amplifier module. In an embodiment, the vector amplifier module injecting the fluid into the device from a power source provided externally thereby the device being bladeless. In an embodiment, the vector amplifier module including a nozzle for injecting the fluid into the device received from an external power source and accelerating the fluid through COANDA effect and redirecting the accelerated fluid through the vector thrust mechanism for generating the thrust.

In accordance with an embodiment, the device provided in the vehicle by means selected from a group consisting of externally attached to the vehicle, attached to wing of the vehicle, embedded into the vehicle, embedded into wing of the vehicle, semi-embedded into the vehicle, and semi-embedded into wing of the vehicle.

In accordance with an embodiment, the device including plurality of vector thrust mechanisms and plurality of power sources for generating thrust in the predetermined directions and the vector thrust mechanism and the power sources combined based on the thrust required for the vehicle.

In accordance with an embodiment, the device removably attached to the vehicle and the power source and the vector thrust mechanism removably attached to the device.

In accordance with an embodiment, the power module fluidly connected to a power source selected from a group consisting of ducted fan, centrifugal fan, axial fan and jet engine.

In accordance with an embodiment, the device combined with a propulsion system provided in the vehicle for generating additional thrust.

In accordance with an embodiment, an exhaust module duct provided for housing the vector thrust mechanism and the exhaust module and a cross-sectional shape of the exhaust module duct reducing turbulence of the accelerated fluid.

In accordance with an embodiment, the predetermined direction including vertical and horizontal for generating thrust in vertical direction and horizontal direction.

In accordance with an embodiment, the exhaust including a vertical exhaust provided for letting the fluid through vertical direction thereby generating vertical exhaust and a horizontal exhaust provided for letting the fluid through horizontal direction thereby generating horizontal exhaust.

In accordance with an embodiment, the vector thrust mechanism movable relative to the device for redirecting the fluid; the vector thrust mechanism connected to a mechanism for automating the movement; and the mechanism selected from a group consisting of servo motor, electric motor, non-electric motor, actuator and mechanical linkage.

In accordance with an embodiment, wherein the predetermined angle ranging from 0 degrees to 360 degrees.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1A illustrates a perspective view of ducted fan as a power source, according to an embodiment herein;

FIG. 1B illustrates a perspective view of a centrifugal fan/compressor as a power source, according to an embodiment herein;

FIG. 1C illustrates a perspective view of an axial fan/compressor as a power source, according to an embodiment herein;

FIG. 1D illustrates a perspective view of a jet engine as a power source, according to an embodiment herein;

FIG. 2A illustrates a perspective view of a single device assembly, according to an embodiment herein;

FIG. 2B illustrates a sectional perspective view of the single device assembly, according to an embodiment herein;

FIG. 3 illustrates a perspective view of a power module, according to an embodiment herein;

FIG. 4A illustrates a sectional side view of a device providing horizontal thrust, according to an embodiment herein;

FIG. 4B illustrates a sectional side view of the device providing vertical thrust, according to an embodiment herein;

FIG. 5A illustrates a perspective view of a device without case with a power source, a vector thrust mechanism and an exhaust module, according to an embodiment herein;

FIG. 5B illustrates a perspective view of the exhaust duct of the device, according to an embodiment herein;

FIG. 5C illustrates a sectional side view of the vector thrust mechanism and exhaust module of the device providing horizontal thrust, according to an embodiment herein;

FIG. 5D illustrates a sectional side view of the vector thrust mechanism and exhaust module of the device providing vertical thrust, according to an embodiment herein;

FIG. 5D illustrates a sectional side view of the of the vector thrust mechanism and exhaust module of the device redirecting a working fluid through a horizontal exhaust, according to an embodiment herein;

FIG. 6A illustrates an upper perspective view of a device without case with a two-power source and a vector thrust mechanism, according to another embodiment herein;

FIG. 6B illustrates a lower perspective view of the device without case with a two-power source and a vector thrust mechanism, according to another embodiment herein;

FIG. 6C illustrates a perspective sectional view of the device without case with a two-power source and a vector thrust mechanism, according to another embodiment herein;

FIG. 6D illustrates a perspective sectional view of the device without case with a two-power source and a vector thrust mechanism, according to another embodiment herein;

FIG. 7A illustrates a sectional view of an over a wing section device redirecting a working fluid through a horizontal exhaust, according to an embodiment herein;

FIG. 7B illustrates a sectional view of an over a wing section device redirecting a working fluid through a vertical exhaust, according to an embodiment herein;

FIG. 8A illustrates a sectional view of a semi embedded into a wing section device redirecting a working fluid through a horizontal exhaust, according to an embodiment herein;

FIG. 8B illustrates a sectional view of a semi embedded into a wing section device redirecting a working fluid through a vertical exhaust, according to an embodiment herein;

FIG. 9A illustrates a sectional side view of a device with a power source and a vector thrust mechanism providing horizontal thrust, according to an embodiment herein;

FIG. 9B illustrates a sectional side view of a device with a power source and a vector thrust mechanism providing vertical thrust, according to an embodiment herein;

FIG. 10A illustrates a perspective view of a device without case including a power source and a vector thrust mechanism, according to another embodiment herein;

FIG. 10B illustrates a perspective view of a vector thrust mechanism, according to another embodiment herein;

FIG. 10C illustrates a sectional side view of the vector thrust mechanism, according to another embodiment herein;

FIG. 10D illustrates a sectional side view of the vector thrust mechanism, according to another embodiment herein;

FIG. 11A illustrates sectional side view of a device with a power source and a vector thrust foldable bucket mechanism providing horizontal thrust, according to another embodiment herein;

FIG. 11B illustrates sectional side view of a device with a power source and a vector thrust foldable bucket mechanism providing vertical thrust, according to another embodiment herein;

FIG. 12A illustrates a perspective view of a device with a power source and a vector thrust foldable bucket mechanism in a retracted position, according to an embodiment herein;

FIG. 12B illustrates a perspective view of a device with a power source and a vector thrust foldable bucket mechanism in an expanded position, according to an embodiment herein;

FIG. 12C illustrates a sectional side view of the device with a power source and a vector thrust foldable bucket mechanism in a retracted position, according to an embodiment herein;

FIG. 12D illustrates a sectional side view of a device with a power source and a vector thrust foldable bucket mechanism in an expanded position, according to an embodiment herein;

FIG. 13A illustrates a sectional side view of a device with a power source and a vector thrust rotating mechanism providing horizontal thrust, according to an embodiment herein;

FIG. 13B illustrates a sectional side view of a device with a power source and a vector thrust rotating mechanism providing vertical thrust, according to an embodiment herein;

FIG. 14A illustrates a perspective view of a device with a power source and a vector thrust rotating mechanism providing horizontal thrust, according to an embodiment herein;

FIG. 14B illustrates a side view of the device with the power source and the vector thrust rotating mechanism providing horizontal thrust, according to an embodiment herein;

FIG. 14C illustrates a side sectional view of the device with the power source and the vector thrust rotating mechanism providing horizontal thrust, according to an embodiment herein;

FIG. 14D illustrates a front perspective view of a device with a power source and a vector thrust rotating mechanism providing vertical thrust, according to an embodiment herein;

FIG. 14E illustrates a rear perspective view of the device with a power source and a vector thrust rotating mechanism providing vertical thrust, according to an embodiment herein;

FIG. 14F illustrates a side view of the device with a power source and a vector thrust rotating mechanism providing vertical thrust, according to an embodiment herein;

FIG. 14G illustrates a side sectional view of the device with a power source and a vector thrust rotating mechanism providing vertical thrust, according to an embodiment herein;

FIG. 15A illustrates a perspective view of a device with a power source and a vector thrust cascade vanes mechanism providing horizontal thrust, according to an embodiment herein;

FIG. 15B illustrates a perspective view of a device with a power source and a vector thrust cascade vanes mechanism providing vertical thrust, according to an embodiment herein;

FIG. 16A illustrates a perspective view of a device with a vector amplifier module with a vector thrust mechanism, according to an embodiment herein;

FIG. 16B illustrates a perspective sectional view of a device with a vector amplifier module with a vector thrust mechanism, according to an embodiment herein;

FIG. 16C illustrates a perspective sectional view of a device with a vector amplifier module with a vector thrust ventral flap mechanism, according to an embodiment herein;

FIG. 17A illustrates a perspective view of a vector amplifier module with a vector thrust ventral flap mechanism, according to an embodiment herein;

FIG. 17B illustrates a sectional side view of a vector amplifier module with a vector thrust ventral flap mechanism providing vertical thrust, according to an embodiment herein;

FIG. 17C illustrates a sectional side view of a vector amplifier module with a vector thrust ventral flap mechanism providing horizontal thrust, according to an embodiment herein;

FIG. 17D illustrates a perspective view of a twin vector amplifier module with a vector thrust ventral flap mechanism, according to an embodiment herein;

FIG. 17E illustrates a sectional side view of the twin vector amplifier module with a vector thrust ventral flap mechanism providing horizontal thrust, according to an embodiment herein;

FIG. 18A illustrates a perspective view of a vector amplifier module with external vectoring vector three flap mechanism, according to another embodiment herein;

FIG. 18B illustrates a sectional side view of a vector amplifier module with external vectoring vector three flap mechanism providing horizontal thrust, according to another embodiment herein;

FIG. 18C illustrates a sectional side view of a vector amplifier module with external vectoring vector three flap mechanism providing vertical thrust, according to another embodiment herein;

FIG. 19A illustrates a perspective view of a vector amplifier module with a vector thrust bucket mechanism, according to another embodiment herein;

FIG. 19B illustrates a sectional side view of a vector amplifier module with a vector thrust bucket mechanism, providing vertical thrust, according to another embodiment herein;

FIG. 19C illustrates a sectional side view of a vector amplifier module with a vector thrust bucket mechanism, providing horizontal thrust, according to another embodiment herein;

FIG. 19D illustrates a perspective view of a vector amplifier module with a vector thrust foldable bucket mechanism in a retracted position for imparting horizontal thrust, according to another embodiment herein;

FIG. 19E illustrates a sectional side view of a vector amplifier module with a vector thrust foldable bucket mechanism in a retracted position, according to another embodiment herein position for imparting horizontal thrust;

FIG. 19F illustrates a perspective view of a vector amplifier module with a vector thrust foldable bucket mechanism in a deployed position for imparting vertical thrust, according to another embodiment herein;

FIG. 19G illustrates a side sectional view of a vector amplifier module with a vector thrust foldable bucket mechanism in a deployed position for imparting vertical thrust, according to another embodiment herein;

FIG. 20A illustrates a perspective view of a vector amplifier module with a vector thrust rotating mechanism providing horizontal thrust, according to another embodiment herein;

FIG. 20B illustrates a side sectional view of the vector amplifier module with a vector thrust rotating mechanism providing horizontal thrust, according to another embodiment herein;

FIG. 20C illustrates a perspective view of a vector amplifier module with a vector thrust rotating mechanism providing vertical thrust, according to another embodiment herein;

FIG. 20D illustrates a side view of a vector amplifier module with a vector thrust rotating mechanism providing vertical thrust, according to another embodiment herein;

FIG. 20E illustrates a side sectional view of a vector amplifier module with a vector thrust rotating mechanism providing vertical thrust, according to another embodiment herein;

FIG. 21A illustrates a side sectional view of a vector amplifier module with a vector thrust cascade vanes mechanism providing horizontal thrust, according to another embodiment herein;

FIG. 21B illustrates a side sectional view of a vector amplifier module with a vector thrust cascade vanes mechanism providing vertical thrust, according to another embodiment herein;

FIG. 22A illustrates a perspective view of an asymmetrical shape bladeless thruster geometry of a vector amplifier module, according to an embodiment herein;

FIG. 22B illustrates a perspective sectional view of the asymmetrical shape bladeless thruster geometry of a vector amplifier module, according to an embodiment herein;

FIG. 22C illustrates a perspective view of an asymmetrical oval shaped shape bladeless thruster geometry of a vector amplifier module, according to another embodiment herein;

FIG. 22D illustrates a perspective sectional view of an asymmetrical oval shaped shape bladeless thruster geometry of a vector amplifier module, according to another embodiment herein;

FIG. 23A illustrates a perspective view of a device with plurality of vectored thrust mechanisms, according to another embodiment herein;

FIG. 23B illustrates a perspective view of the devices without case with plurality of vectored thrust mechanisms, according to another embodiment herein;

FIG. 23C illustrates a perspective view of a disassembled device with plurality of vectored thrust mechanisms, according to another embodiment herein;

FIG. 24A illustrates a perspective view of a device with vectored thrust ventral flap mechanism, according to another embodiment herein;

FIG. 24B illustrates a perspective view of the device with vectored thrust ventral flap mechanism providing horizontal thrust, according to another embodiment herein;

FIG. 24C illustrates a perspective view of the device with vectored thrust ventral flap mechanism providing vertical thrust, according to another embodiment herein;

FIG. 25A illustrates a perspective view of a flying vehicle externally attached to a plurality of devices with external vectoring flap mechanism, according to an embodiment herein;

FIG. 25B illustrates a magnified perspective view of a flying vehicle externally attached to a plurality of devices with external vectoring flap mechanism, according to an embodiment herein;

FIG. 25C illustrates a perspective view of the device with external vectoring flap mechanism attached to the flying vehicle, according to an embodiment herein;

FIG. 25D illustrates a perspective view of the plurality of devices with external vectoring flap mechanism attached to the flying vehicle, according to an embodiment herein;

FIG. 26A illustrates a perspective view of a flying vehicle with four-point distribution propulsion systems.

FIG. 26B illustrates a perspective view of a flying vehicle with center of gravity distribution propulsion system, according to an embodiment herein;

FIG. 26C illustrates a perspective view of a flying with three-point distribution propulsion systems, according to an embodiment herein;

FIG. 26D illustrates a perspective view of a flying vehicle with four-point distribution propulsion system, according to another embodiment herein;

FIG. 26E illustrates a perspective view of a flying vehicle with mixed distribution propulsion system, according to another embodiment herein;

FIG. 27A illustrates a bottom view of a flying vehicle with ducted fan embedded into the nose and rear devices with vectored thrust mechanism, according to another embodiment herein;

FIG. 27B illustrates a perspective view of a flying vehicle with shrouded rotors attached at front wing tips and devices with vectored thrust mechanism attached to rear wings, according to an embodiment herein;

FIG. 27C illustrates a perspective view of a flying vehicle with a single ducted fan embedded into the nose and devices with vectored thrust mechanism embedded to the rear, according to an embodiment herein;

FIG. 27D illustrates a perspective view of a flying vehicle with shrouded rotors attached at front wing tips and devices with vectored thrust mechanism embedded to rear body, according to an embodiment herein;

FIG. 27E illustrates a perspective view of a flying vehicle with bladeless thruster attached at front wing tips and devices with vectored thrust mechanism attached externally to the wing, according to an embodiment herein;

FIG. 28A illustrates a perspective view of a flying vehicle with a single ducted fan embedded into the rear of the vehicle body and devices with vector thrust mechanism attached at front wing tips, according to an embodiment herein;

FIG. 28B illustrates a perspective view of a flying vehicle with shrouded rotors attached at rear wing tips and devices with vectored thrust mechanism attached to front wing tips, according to an embodiment herein;

FIG. 28C illustrates a perspective view of a flying vehicle with ducted fan embedded into the nose, shrouded rotors attached at front wing tips and devices with vectored thrust mechanism embedded into rear of the vehicle, according to an embodiment herein;

FIG. 28D illustrates a perspective view of a flying vehicle with ducted fan embedded into the nose, shrouded rotors attached at front wing tips and devices with vectored thrust mechanism externally attached to rear of the vehicle, according to an embodiment herein;

FIG. 28E illustrates a perspective view of a flying vehicle with ducted fan embedded into the rear of the body, shrouded rotors attached at rear wing tips and devices with vectored thrust mechanism externally attached at front wing tips, according to an embodiment herein;

FIG. 29A illustrates an upper perspective view of a device without case with a power source and two vector thrust ventral flap mechanism exhaust modules, according to another embodiment herein;

FIG. 29B illustrates a lower perspective view of the device without case with a power source and two vector thrust ventral flap mechanism exhaust modules, according to another embodiment herein;

FIG. 29C illustrates a perspective sectional view of the device without case with a power source and two vector thrust ventral flap mechanism exhaust modules, according to another embodiment herein;

FIG. 30A illustrates a perspective sectional view of a device without case with a power source and one swivel elbow mechanism exhaust module in horizontal flight position, according to another embodiment herein;

FIG. 30B illustrates a perspective sectional view of a device without case with a power source and one swivel elbow mechanism exhaust module in vertical flight position, according to another embodiment herein;

FIG. 30C illustrates a perspective sectional view of a device without case with a power source and double swivel elbow mechanism exhaust module in horizontal flight position, according to another embodiment herein;

FIG. 30D illustrates a perspective sectional view of a device without case with a power source and double swivel elbow mechanism exhaust module in vertical flight position, according to another embodiment herein;

FIG. 31A illustrates an upper perspective view of a vector amplifier module without case with two integrated vector thrust ventral flap mechanism, according to another embodiment herein;

FIG. 31B illustrates a lower perspective view of the vector amplifier module without case with two integrated vector thrust ventral flap mechanism, according to another embodiment herein;

FIG. 31C illustrates a perspective sectional view of the vector amplifier module without case with two integrated vector thrust ventral flap mechanism, according to another embodiment herein;

FIG. 32A illustrates a perspective sectional view of a vector amplifier module without case with integrated single swivel elbow mechanism in horizontal flight position, according to another embodiment herein;

FIG. 32B illustrates a perspective sectional view of a vector amplifier module without case with integrated single swivel elbow mechanism in vertical flight position, according to another embodiment herein;

FIG. 32C illustrates a perspective sectional view of a vector amplifier module without case with integrated double swivel elbow mechanism in horizontal flight position, according to another embodiment herein;

FIG. 32D illustrates a perspective sectional view of a vector amplifier module without case with integrated double swivel elbow mechanism in vertical flight position, according to another embodiment herein;

FIG. 33A illustrates a sectional side view scheme of a device with a power source and a vector thrust ventral rotating mechanism providing horizontal thrust, according to another embodiment herein;

FIG. 33B illustrates a sectional side view scheme of a device with a power source and a vector thrust ventral rotating mechanism providing vertical thrust, according to another embodiment herein;

FIG. 34A illustrates a sectional side view scheme of a vector amplifier module without case with a vector thrust ventral rotating mechanism providing horizontal thrust, according to another embodiment herein; and

FIG. 34B illustrates a sectional side view scheme of a vector amplifier module without case with a vector thrust ventral rotating mechanism providing vertical thrust, according to another embodiment herein.

### DETAILED DESCRIPTION OF THE PREFERRED EMBODIMENTS

The embodiments herein and the various features and advantageous details thereof are explained more fully with reference to the non-limiting embodiments and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

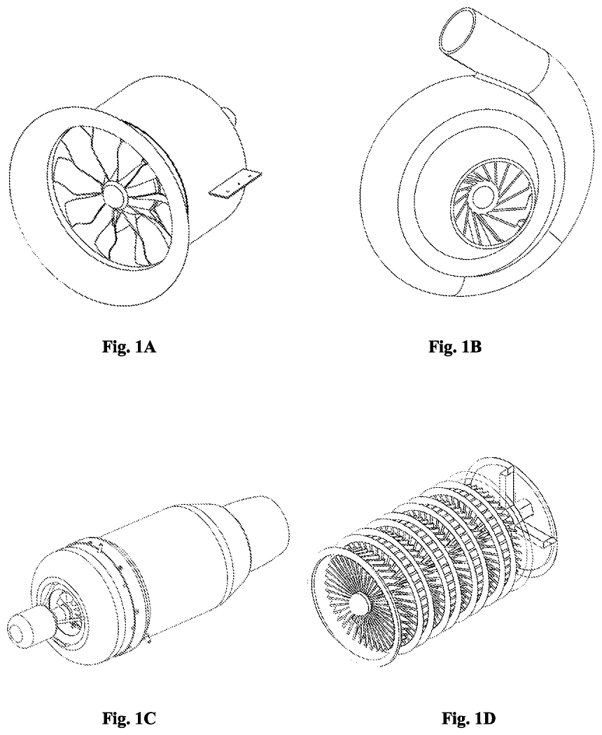

As mentioned above, there is a need for an improved and advanced propulsion system with a vector thrust mechanism. In particular, there is a need for a propulsion system of modular design provided with vector thrust mechanisms for imparting VTOL/STOL capabilities to a vehicle with better efficiency. The embodiments herein achieve this by providing “A modular device for propulsion in a vehicle”. Referring now to the drawings, and more particularly to FIG. 1 through FIG. 34, where similar reference characters denote corresponding features consistently throughout the figures, there are shown preferred embodiments.

In an embodiment, a device for propulsion is provided in a vehicle. The device for propulsion including but not limited to a power module and an exhaust module. The power module is provided for injecting a fluid into the device at an inlet and accelerating the injected fluid for generating a thrust. The accelerated fluid exits the power module at an outlet. The exhaust module redirecting the accelerated fluid from the outlet of the power module to a predetermined direction. In an embodiment, the exhaust module including a vector thrust mechanism for redirecting the accelerated fluid to the predetermined direction. Geometry of the vector thrust mechanism is designed for redirecting the fluid exiting the power module with efficiency, minimum power loss and without generation of significant turbulence on the fluid. In an embodiment, the predetermined direction is the direction for generating the thrust in the vehicle. The predetermined direction including but not limited to vertical and horizontal. The vector thrust mechanism redirecting the fluid to a plurality of exhausts provided in the exhaust module attached at a plurality of directions in the vehicle for regulating the accelerated fluid and letting out the fluid at the predetermined direction for generating the thrust and maneuvering the vehicle in the predetermined direction.

In an embodiment, geometry and a mechanism of the vector thrust mechanism is variable based on the direction of thrust and amount of thrust required for maneuvering the vehicle.

In an embodiment, the vector thrust mechanism including but not limited to a ventral flap, foldable bucket mechanism, bucket mechanism, rotating mechanism, external vectoring flap mechanism and cascading vanes mechanism.

In an embodiment, the device including additional components for improving performance including but not limited to control surfaces, noise suppressors, and variable geometry exhaust.

In an embodiment, the power module including the power source, the vector thrust mechanism, the exhaust module including exhausts are attachable and detachable from the device, thereby facilitating swapping, exchange, replacement, or removal of the power module, vector thrust mechanism or the exhaust module during maintenance and upgradation. This reduces operation cost of the vehicle.

FIG. 1A, FIG. 1B, FIG. 1C and FIG. 1D illustrate a perspective view of a power source. In an embodiment, a power module is provided for injecting a working fluid into a device and accelerating the injected working fluid. The power module includes a power source for accelerating the working fluid. FIG. 1A illustrates a ducted fan as the power source, FIG. 1B illustrates a centrifugal fan/compressor as the power source, FIG. 1C illustrates an axial fan/compressor as the power source and FIG. 1D illustrates a jet engine as the power source. In an embodiment, the ducted fan, the centrifugal fan/compressor, and the axial fan/compressor are driven by a motor for accelerating the fluid. In an embodiment, the motor including but not limited to an electric motor and a non-electric motor. In an embodiment, the jet engine is powered by a fuel.

The power source accelerates the injected working fluid for providing thrust. Amount of the thrust produced by the power source in the power module is sufficient for moving the vehicle in one direction.

In an embodiment, the power module includes a case for housing the power source. Design of the power source is based on the power source, size of the power size, shape of the power source. In an embodiment, the power module is removably attached to the device for electric propulsion.

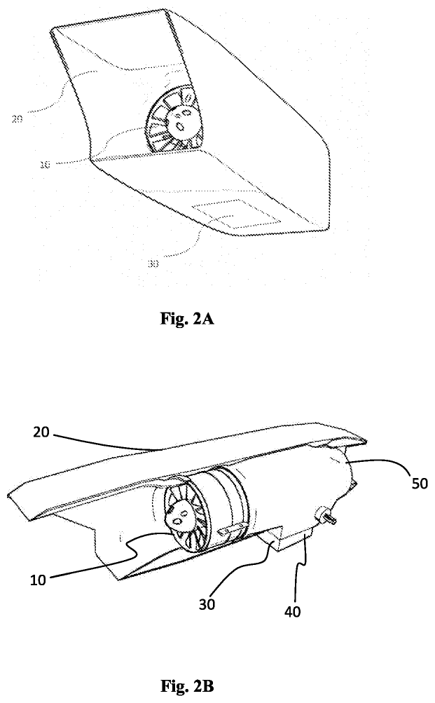

FIG. 2A illustrates a perspective view of a single device assembly for electric propulsion. In an embodiment, the single device assembly for electric propulsion including a power source 10, a case 20 and an exhaust module 30. The power source is a ducted fan 10 house in the case 20. In an embodiment, a shape and size of the case is based on the shape and size of the power source 10 and the exhaust module 30.

FIG. 2B illustrates a sectional perspective view of the single device assembly for electric propulsion. In an embodiment, the sectional view of the single device assembly illustrating the exhaust module 30 including a vertical exhaust 40 and a horizontal exhaust 50.

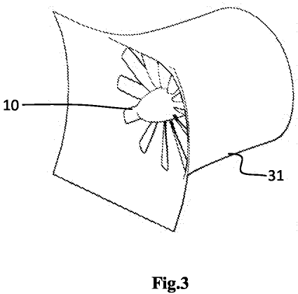

FIG. 3 illustrates a perspective view of a power module. The power module includes a ducted fan as the power source 10 placed in a power module duct 31.

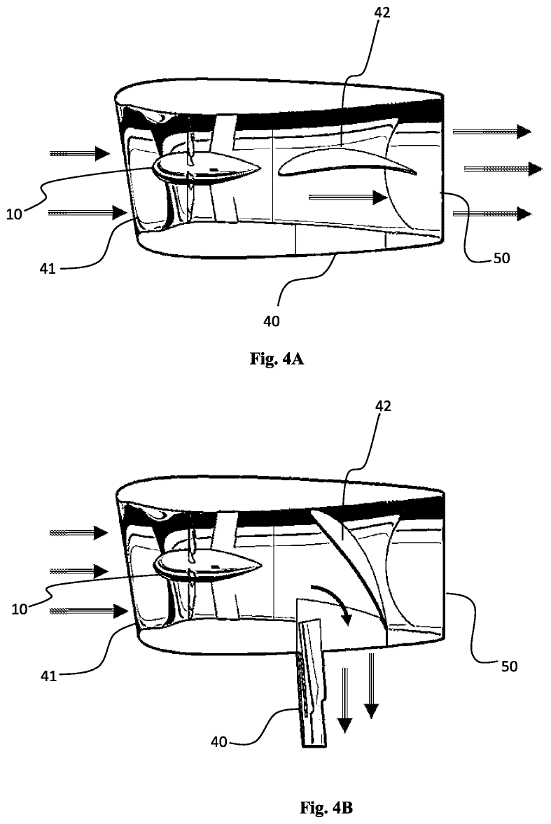

FIG. 4A illustrates a sectional side view of a device providing horizontal thrust. In an embodiment, the device including an inlet 41, a ducted fan as the power source 10 and a ventral flap 42. In an embodiment, fluid enters the device through the inlet 41 and accelerated by the ducted fan 10. The ventral flap 42 is positioned at a middle of the device for directing the accelerated fluid from the ducted fan 10 to the vertical exhaust 40 or the horizontal exhaust. The vertical exhaust 40 is a closed position and the horizontal exhaust 50 is in an open position.

In an embodiment, the ventral flap 42 is positioned horizontally for directing the accelerated fluid to the horizontal exhaust 50 thereby generating a horizontal thrust in the vehicle.

FIG. 4B illustrates a sectional side view of a device providing vertical thrust. In an embodiment, horizontal exhaust 50 is in a closed position and the vertical exhaust 40 is in an open position. The ventral flap 42 is positioned vertically for directing the accelerated fluid from the ducted fan 10 to the vertical exhaust 40, thereby generating vertical thrust in the vehicle.

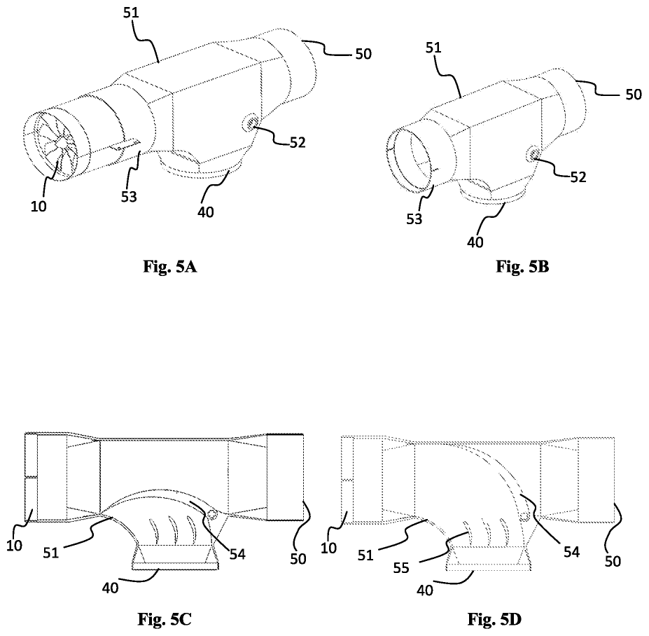

FIG. 5A illustrates a perspective view of a device without case, with a power source, a vector thrust mechanism, and an exhaust module. The device includes a ducted fan as the power source 10 in the power module, an exhaust module duct 51, the vertical exhaust 40, the horizontal exhaust 50 and an anti-leak side geometry 52. A power module duct 53 is provided in the exhaust module duct 51 for engaging with the power module including the power source 10.

FIG. 5B illustrates a perspective view of the exhaust duct of the device. The exhaust duct includes the power module duct 53 for fitting with the power module including the power source 10. The exhaust module duct 51 including the horizontal exhaust 50 and the vertical exhaust 40.

FIG. 5C illustrates a sectional side view of the exhaust duct including the vector thrust mechanism and exhaust module of the device providing horizontal thrust. The vector thrust mechanism includes a ventral flap 54 for redirecting the accelerated fluid to the predetermined direction. The ventral flap 54 includes a curved geometry for redirecting the working fluid to a predetermined direction at a predetermined angle. In an embodiment, the ventral flap 54 is rotatable about a pivot for opening and closing the horizontal exhaust 50 and the vertical exhaust 40. In an embodiment, the ventral flap 54 is in a horizontal position thereby closing the vertical exhaust 40 and allowing the fluid to flow through the horizontal exhaust 50, thereby generating a horizontal thrust.

In an embodiment, a shape and geometry of the ventral flap 54 is designed based on requirement of thrust and redirection of angle. The ventral flap 54 is placed in the exhaust module duct 51 at a position for opening and closing the vertical exhaust 40 and the horizontal exhaust 50. The ventral flap 54 is attached to the exhaust module duct 54 through a shaft. The shaft is connected from one side of the exhaust module duct to another side of the exhaust module duct. The ventral flap 54 is rotatable about the shaft.

In an embodiment, a rotating mechanism is connected to the ventral flap 54 for rotating the ventral flap 54 to a predetermined angle for opening and/or closing the vertical exhaust 40 and/or the horizontal exhaust 50. In an embodiment, the rotating mechanism including but not limited to a servo, an actuator, a motor. The shaft is connected to sides of the exhaust module at the anti leak side geometry for preventing fluid leakage from the exhaust module duct 51.

In an embodiment, a shape of the vertical exhaust 40 and the horizontal exhaust 50 including but not limited to convergent, divergent shape and variable shape. In a preferred embodiment, shape of the vertical exhaust and the horizontal exhaust is variable for regulating the fluid as desirable to obtain a desired thrust and performance on flight path of the vehicle.

In an embodiment, as shown in FIGS. 5A-5D, shape of cross-section of the exhaust module duct 51 varies from a circular shape at the power module duct 53, a square shape at the ventral flap 54, and a circular shape at the horizontal exhaust 50.

In an embodiment, the device is attached to the vehicle for generating the thrust and maneuvering the vehicle to a desired direction. In an embodiment, attachment of the device to the vehicle including the device embedded into the vehicle body. In another embodiment, attachment of the device to the vehicle including the device semi embedded into the vehicle body. In another embodiment, the device is semi embedded into a wing section of the vehicle body.

FIG. 5D illustrates a sectional side view of the exhaust duct including the vector thrust mechanism and exhaust module of the device providing vertical thrust. The ventral flap 54 is in a vertical position closing the horizontal exhaust and allowing the fluid through the vertical exhaust 40. A plurality of turning vanes 55 are attached to vertical exhaust for effectively redirecting the fluid through the vertical exhaust, thereby generating vertical thrust. The turning vanes 55 force the fluid to move straight in a desired direction and correct unwanted angles of the fluid.

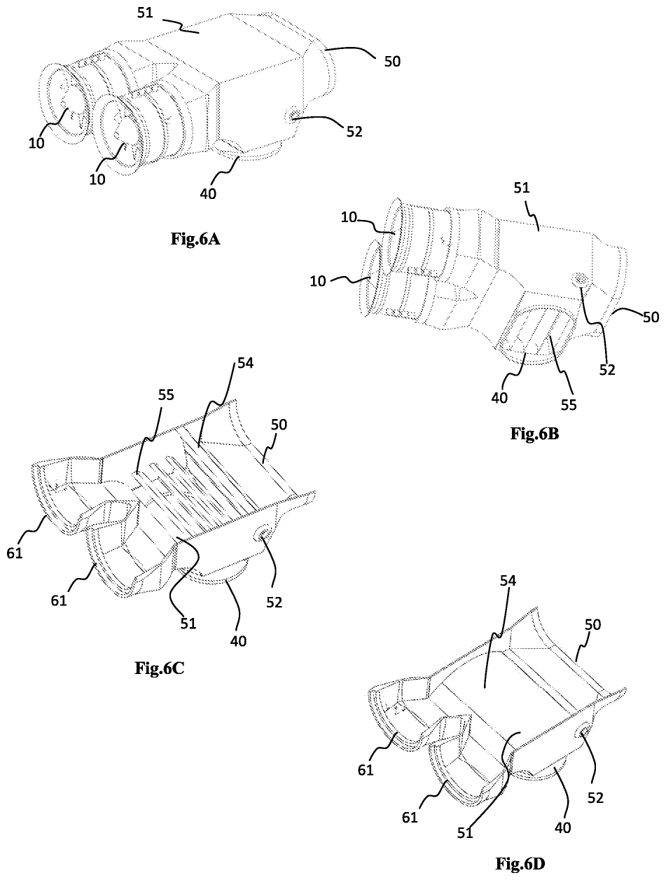

FIG. 6A illustrates an upper perspective view of a device without case with a two-power source and a vector thrust mechanism. In an embodiment, the power module includes a two-power source 10 including two ducted fans, wherein the plurality of power sources 10 and a single exhaust module reduces quantity of exhaust for the propulsion.

FIG. 6B illustrates a lower perspective view of the device without case with a two-power source and a vector thrust mechanism. The vertical exhaust 40 includes the turning vanes for redirecting the fluid from the power source through the vertical exhaust 40.

FIG. 6C illustrates a perspective sectional view of the device without case with a two-power source and a vector thrust mechanism. The device includes the ventral flap 54 as the vector thrust mechanism for redirecting the fluid from the power module to the vertical exhaust 40 or the horizontal exhaust 50. The device includes power module ducts 61 for housing the power sources 10. In an embodiment, the horizontal exhaust 50 in a closed position by the position of ventral flap 54. The turning vanes 55 are open for directing the fluid through the vertical exhaust 40, thereby generating vertical thrust.

FIG. 6D illustrates a perspective sectional view of the device without case with a two-power source and a vector thrust mechanism. The ventral flap 54 is in a horizontal position for blocking the fluid to the vertical exhaust 40 and redirecting the fluid through the horizontal exhaust 50.

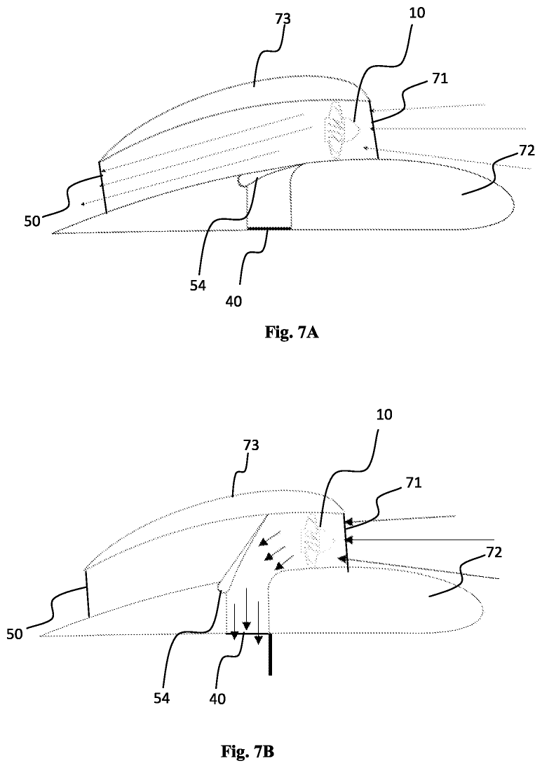

FIG. 7A illustrates a sectional view of an over a wing section device redirecting a working fluid through a horizontal exhaust. A device 73 for propulsion is placed over a wing 72 of a vehicle for generating thrust and maneuvering the vehicle. The power source 10 is positioned above the wing 72 of the vehicle. In an embodiment, the power source 10 is a ducted fan. Fluid enters the power source 10 through an inlet 71. The ventral flap 54 is provided on the wing 72 for opening and closing the vertical exhaust 40 and the horizontal exhaust. The vertical exhaust 40 in integrated with the wing 72. In an embodiment, the ventral flap 54 is in a horizontal position for closing the vertical exhaust 40 and opening the horizontal exhaust 50, thereby redirecting the fluid through the horizontal exhaust. In an embodiment, the device 73 is adapted for providing thrust and power requirements in each flight stage of the vehicle. The ventral flap 54 is adapted to shape of surface of the wing 72. During forward flight, the ventral flap 54 closes the vertical exhaust 40, thereby allowing the accelerated fluid from the power source 10 to flow over the wing for contributing to the wing lift.

Iii an embodiment, design of the power module, exhaust module and the vector thrust mechanism is adapted to geometry of the wing 72, wherein portion of area of the wing where the device is installed benefits from a greater production of lift than other areas due the high speed of the fluid over the wing section.

FIG. 7B illustrates a sectional view of an over a wing section device redirecting a working fluid through a vertical exhaust. In an embodiment, the ventral flap 54 is in a position blocking the horizontal exhaust 50 and redirecting the fluid through the vertical exhaust 40.

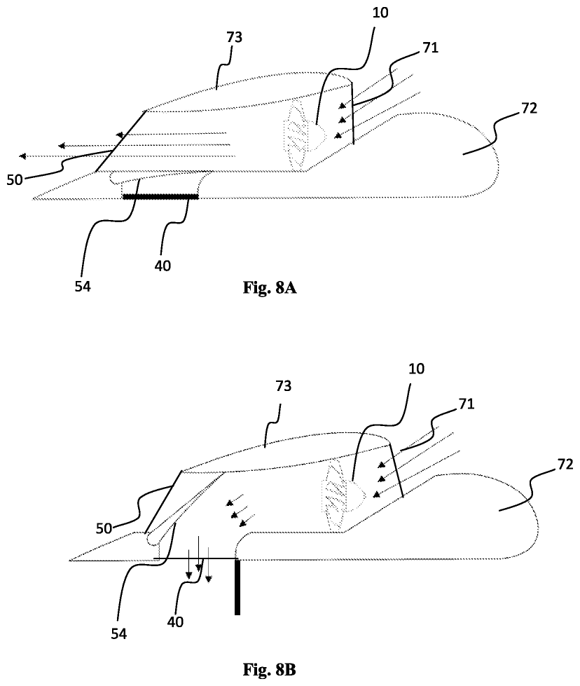

FIG. 8A illustrates a sectional view of a device semi embedded into a wing section redirecting a working fluid through a horizontal exhaust. In an embodiment, the device 73 for propulsion including the power source 10 is semi embedded into a modified wing 72. The ventral flap 54 is in a position redirecting the fluid through the horizontal exhaust 50.

FIG. 8B illustrates a sectional view of a device semi embedded into a wing section redirecting a working fluid through a vertical exhaust. In an embodiment, the ventral flap 54 is in a vertical position redirecting the fluid through the vertical exhaust 40.

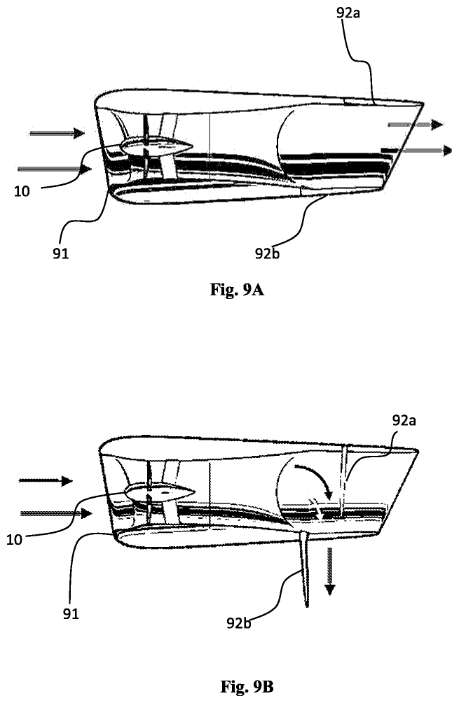

FIG. 9A illustrates a sectional side view of a device with a power source and vector thrust mechanism providing horizontal thrust, according to another embodiment. The vector thrust mechanism is an external vectoring two flap mechanism. The external vectoring two flap mechanism includes the two flaps 92a and 92b provided for redirecting the fluid flowing through the device from an inlet 91 to an exhaust in the rear of the device. The flaps 92a and 92b are rotatable relative to the shaft about an angle. In an embodiment, the angle ranging from 90 degrees to 270 degrees. The flaps 92a and 92b are synchronized for rotating at a desired angle for redirecting the fluid at exhaust. In an embodiment, the flap 92a and 92b in a horizontal position allow the fluid go into horizontal direction, thereby generating horizontal thrust.

FIG. 9B illustrates a sectional side view of a device with a power source and vector thrust mechanism providing vertical thrust. In an embodiment, the flaps 92a and 92b are in a vertical position redirecting the fluid into vertical position, thereby generating vertical thrust.

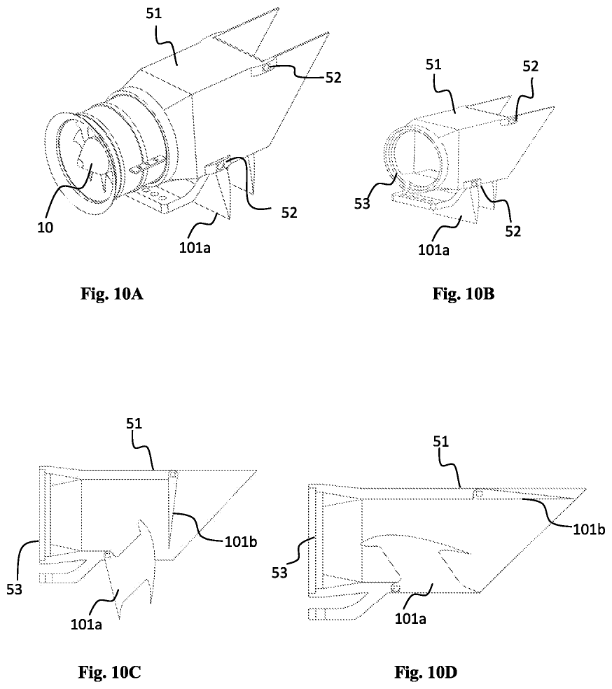

FIG. 10A illustrates a perspective view of a device without case including a power source and vector thrust mechanism, according to another embodiment. The device including the power module including the power source 10. In an embodiment, the power source 10 is a ducted fan. In an embodiment, the vector thrust mechanism is an external vectoring three flaps mechanism.

FIG. 10B illustrates a perspective view of the exhaust module duct 51 including the vector thrust mechanism.

FIG. 10C illustrates a sectional side view of the vector thrust mechanism. In an embodiment, the external vectoring three flaps mechanism includes external flaps 101a and 101b. In an embodiment, the external flaps 101a and 101b are rotatable and synchronized for redirecting the fluid to a horizontal or vertical direction.

FIG. 10D illustrates a sectional side view of the vector thrust mechanism, wherein the external flaps 101a and 101b are rotated and placed in a different position.

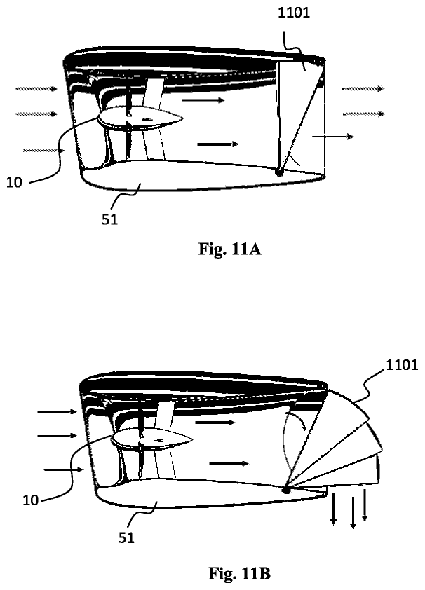

FIG. 11A illustrates sectional side view of a device with a power source and a vector thrust foldable bucket mechanism providing horizontal thrust. In an embodiment, the vector thrust mechanism is a foldable bucket mechanism. The foldable bucket mechanism includes a curved surface 1101. The curved surface is retractable and extendable for redirecting the fluid to the predetermined direction at a predetermined angle. In an embodiment, the curved surface 1101 is in a retracted position. The retracted position of the curved surface 110 allows the fluid horizontally, thereby imparting horizontal thrust.

In an embodiment, the curved surface 1101 is attached to sides of the exhaust module duct 51 through a joint. The curved surface is rotatable relative to the joint to a predetermined angle the necessary degrees for retracting and extending for generating the thrust in the predetermined direction.

In an embodiment, a rotation mechanism is connected to the curved surface 1101 for retracting and extending the curved surface. The rotation mechanism including but not limited to a servo, an actuator.

The retraction of the curved surface creates a first exhaust at a first direction and the extension of the curved surface creates a second exhaust at a second direction.

FIG. 11B illustrates sectional side view of a device with a power source and a vector thrust foldable bucket mechanism providing vertical thrust.

The curved surface 1101 is extended, wherein the extended curved surface redirects the fluid through the second direction. In another embodiment, the curved surface 1101 includes foldable parts for ease of retraction and placement in the vehicle.

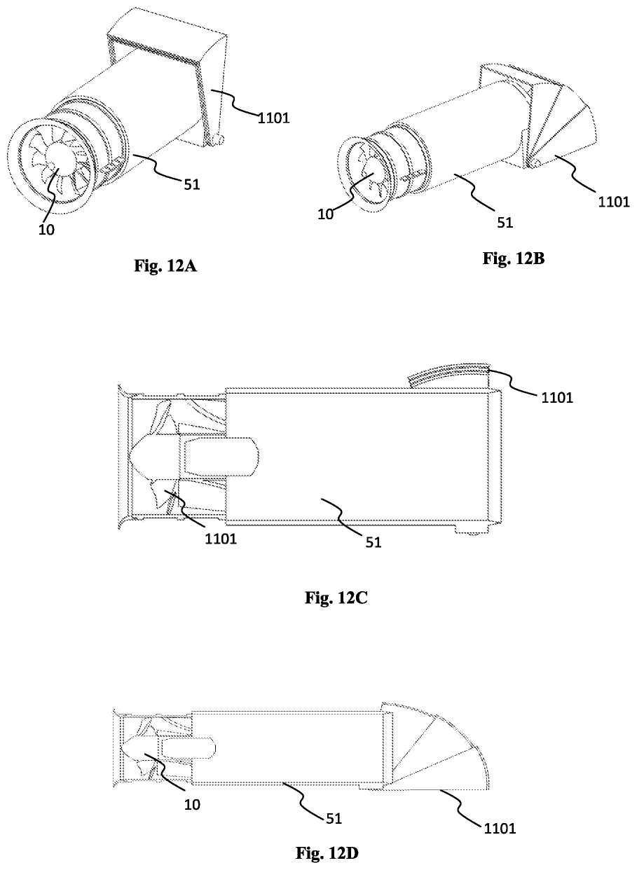

FIG. 12A illustrates a perspective view of a device with a power source and a vector thrust foldable bucket mechanism. In an embodiment, the device including the power source 10, the exhaust module duct 51 and the foldable bucket 1101 in a retracted position.

FIG. 12B illustrates a perspective view of a device with a power source and a vector thrust foldable bucket mechanism. In an embodiment, the device including the power source 10, the exhaust module duct 51 and the foldable bucket 1101 in an expanded position.

FIG. 12C illustrates a sectional side view of the device with the power source and the foldable bucket 1101 in the retracted position.

FIG. 12D illustrates a sectional side view of the device with the power source and the foldable bucket 1101 in the expanded position.

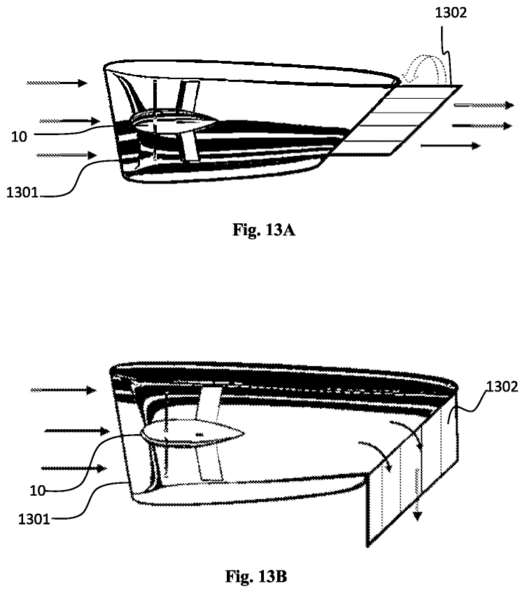

FIG. 13A illustrates a sectional side view of a device with a power source and a vector thrust rotating mechanism providing horizontal thrust. In an embodiment, the vector thrust mechanism including the vector thrust rotating mechanism. In an embodiment, the vector thrust rotating mechanism including a multi-directional duct 1302 for redirecting the fluid to the predetermined angle. The multi-directional duct 1302 is rotatable about a pivot for changing an angle of the exhaust to generate thrust in the predetermined direction.

In an embodiment, fluid entering the device from an inlet 1301, the fluid accelerating in a ducted fan 10 and the multi-directional duct 1302 at a horizontal position allowing the flow of fluid, thereby generating horizontal thrust.

FIG. 13B illustrates a sectional side view of a device with a power source and a vector thrust rotating mechanism providing vertical thrust. In an embodiment, the multi-directional duct 1302 rotated about an angle of 90° for changing an angle of the exhaust to generate thrust in the predetermined direction.

In an embodiment, fluid entering the device from the inlet 1301 and accelerated in the ducted fan 10 flowing through the multi-directional duct 1302 at a vertical position, thereby generating vertical thrust.

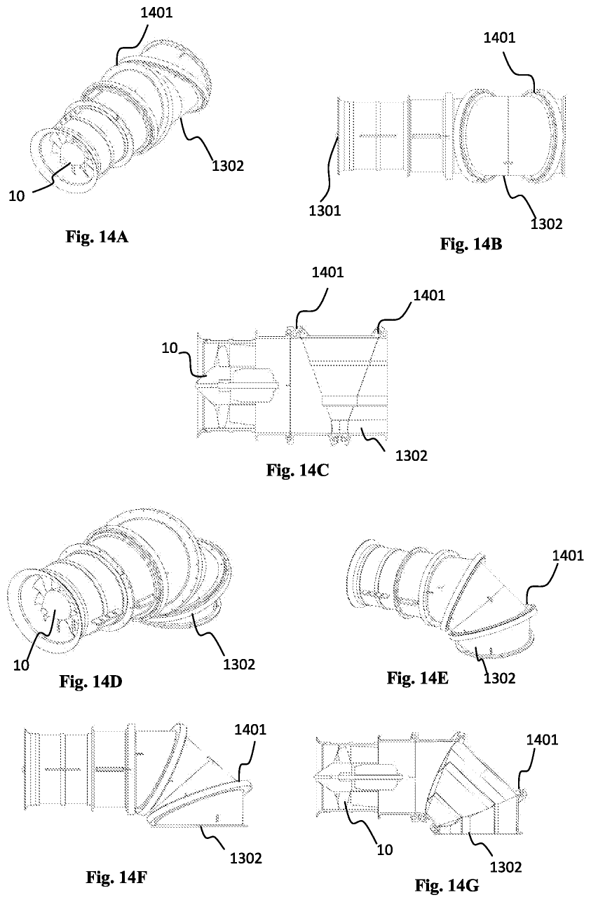

FIG. 14A illustrates a perspective view of a device with a power source and a vector thrust rotating mechanism providing horizontal thrust. In an embodiment, the vector thrust rotating mechanism including the multi-direction duct 1302. The multi-directional duct 1302 including a mechanism for rotating to an angle for changing a direction of exhaust to generate thrust in the predetermined direction. In an embodiment, the mechanism including but not limited to gimbal rings. In an embodiment, the gimbal rings 1401 is a three bearing rotating swivel mechanism rotating an exhaust nozzle for redirecting the fluid and generating thrust in the predetermined direction. In an embodiment, rotation of the gimbal rings in a range of 0°-360°. In a preferred embodiment, the rotation in a range of 0° to 90°. In an embodiment, a rotating mechanism is connected to the gimbal rings for automated rotation, wherein the rotating mechanism including but not limited to servo motors, actuator. The multidirectional duct 1302 including a geometry for changing the direction of the exhaust when rotated to another position.

In an embodiment, the multi-directional duct 1302 is in a horizontal position, thereby allowing flow of fluid horizontally for generating horizontal thrust.

FIG. 14B illustrates a side view of the device with the power source and the vector thrust rotating mechanism providing horizontal thrust.

FIG. 14C illustrates a side sectional view of the device with the power source and the vector thrust rotating mechanism providing horizontal thrust.

FIG. 14D illustrates a front perspective view of a device with a power source and a vector thrust rotating mechanism providing vertical thrust. The gimbal rings 1401 are rotated for changing a direction of the multi-directional duct 1302. In an embodiment, the gimbal rings 1401 rotate the multi-directional duct 1302 by an angle of 90° for allowing the fluid through a vertical direction, thereby generating vertical thrust.

FIG. 14E illustrates a rear perspective view of the device with the power source and a vector thrust rotating mechanism providing vertical thrust.

FIG. 14F illustrates a side view of the device with a power source and a vector thrust rotating mechanism providing vertical thrust.

FIG. 14G illustrates a side sectional view of the device with a power source and a vector thrust rotating mechanism providing vertical thrust.

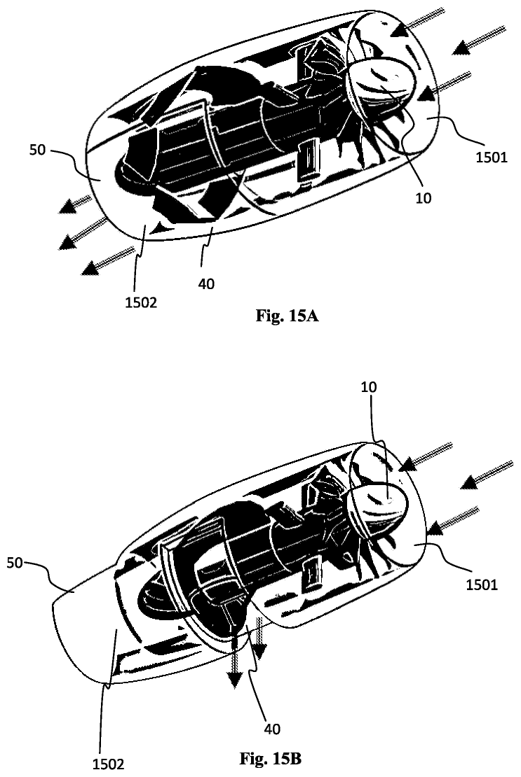

FIG. 15A illustrates a perspective view of a device with a power source and a vector thrust cascade vanes mechanism providing horizontal thrust. In an embodiment, the vector thrust mechanism is a cascade vanes mechanism. The cascade vanes mechanism includes a plurality of spaced segments 1502. The spaced segments 1502 are movable for opening and closing the horizontal exhaust 50 and the vertical exhaust. The spaced segments 1502 form a surface on the device, wherein movement of the spaced segments 1502 opens and closes the vertical exhaust 40. In an embodiment, a secondary mechanism is connected to the spaced segment 1502 for opening and closing the vertical exhaust 40 and the horizontal exhaust 50. The mechanism including but not limited to a hermetic cap, a sliding bottom cover for opening and closing the vertical exhaust.

In an embodiment, the spaced segment 1502 is in a closed position blocking the fluid through the vertical exhaust 40 and allowing the fluid through the horizontal exhaust for generating a horizontal thrust.

FIG. 15B illustrates a perspective view of a device with a power source and a vector thrust cascade vanes mechanism providing vertical thrust. In an embodiment, the spaced segment 1502 is slid for opening the vertical exhaust 40, allowing the fluid through the vertical exhaust for generating a vertical thrust.

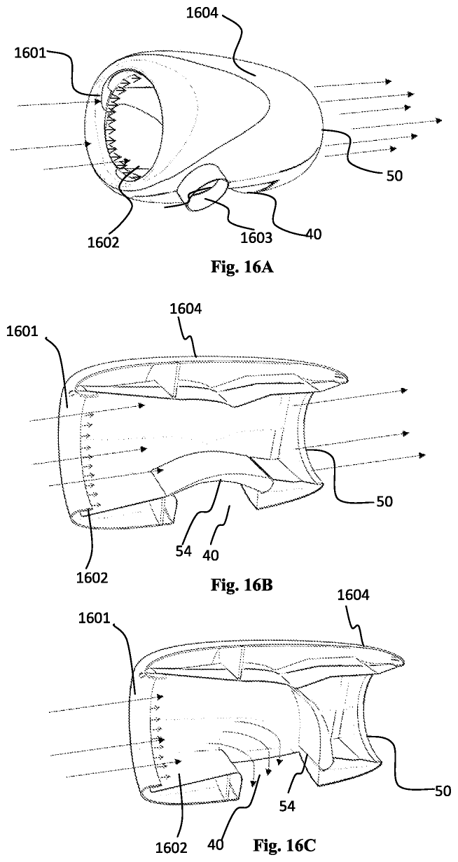

FIG. 16A illustrates a perspective view of a device with a vector amplifier module with a vector thrust mechanism. In an embodiment, the vector amplifier module includes the vector thrust mechanism and the exhaust module integrated in the device. The device including a case is externally attached to the vehicle for generating thrust. In an embodiment, the device including an inlet 1602 for allowing fluid, a nozzle 1602 for injecting accelerated fluid from an external power source into the device, a fluid injecting fixture 1603, a case 1604, the vertical exhaust 40 and the horizontal exhaust 50.

In an embodiment, the device with the vector amplifier module allows the injection of the working fluid into the device without the power source housed inside the power module. In a vehicle with the device with vector amplifier module includes the power source attached to the vehicle body away from the device for propulsion, thereby the inlet 1601 is bladeless. Geometry of the nozzle 1602 allows the fluid at a high pressure coming from the power source, accelerated by COANDA effect into the device. The device includes the fluid injecting fixture 1603 for absorbing and injecting additional fluid from environment.

In an embodiment, the case is provided for externally attaching the device or semi-embedding the device to the vehicle for protecting the device from being hit by foreign objects, allowing grouping of multiple devices arrangement as a set. The case improves performance of the device based on geometry at the inlet and exhaust suppresses noise generated by the device. The case is provided for holding additional control surfaces required for control and stability of the vehicle. In an embodiment, the case enables ease of attachment and removal of the device from the vehicle without requiring disassembly of the device.

The case is provided as a structural frame for supporting and attaching the device or plurality of devices to the vehicle. In another embodiment, body of the vehicle performs function of the case, when the device is embedded into the vehicle.

A shape and size of the case varies according to design of the vehicle and the vector thrust mechanism. In a preferred embodiment, the case is designed as a one-piece for enabling easy installation and removal of the device from the case.

FIG. 16B illustrates a perspective sectional view of the device with a vector amplifier module with a vector thrust mechanism. In an embodiment, the fluid is injected into the device through the inlet 1601, by the nozzle 1602. The integrated vector thrust mechanism including the ventral flap 54, wherein the ventral flap 54 is in a position for allowing the fluid through the horizontal exhaust 50, thereby generating horizontal thrust.

FIG. 16C illustrates a perspective sectional view of the device with a vector amplifier module with a vector thrust ventral flap mechanism. In an embodiment, the ventral flap 54 is in a position for allowing the fluid through the vertical exhaust 40, thereby generating vertical thrust.

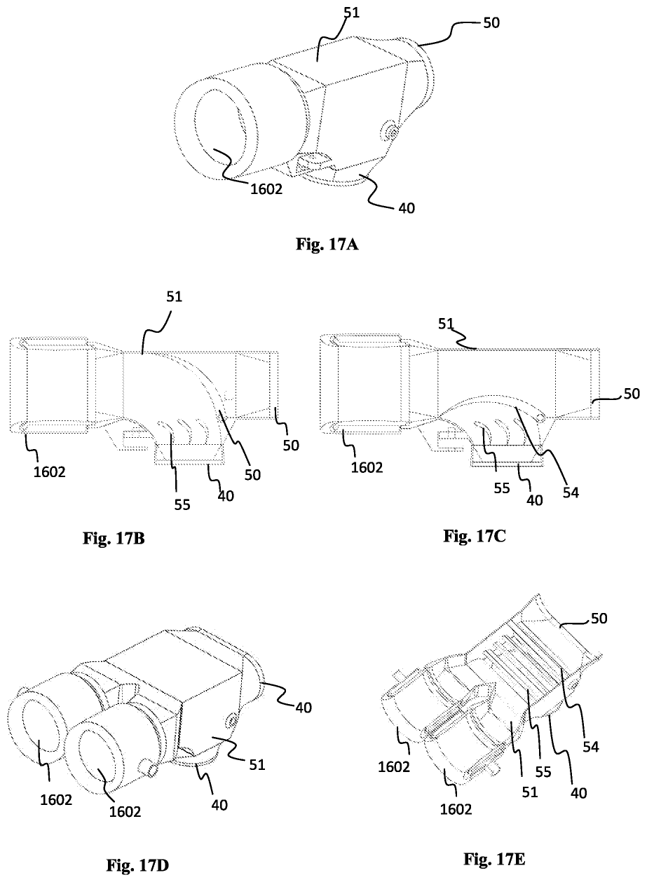

FIG. 17A illustrates a perspective view of a vector amplifier module with a vector thrust ventral flap mechanism. In an embodiment, the vector amplifier module includes a nozzle 1602, for injecting fluid from an external power source into the device. The device is bladeless, wherein the power source for accelerating the fluid is placed externally.

FIG. 17B illustrates a sectional side view of the vector amplifier module with a vector thrust ventral flap mechanism providing vertical thrust.

FIG. 17C illustrates a sectional side view of the vector amplifier module with a vector thrust ventral flap mechanism providing horizontal thrust.

FIG. 17D illustrates a perspective view of a twin vector amplifier module with a vector thrust ventral flap mechanism. In an embodiment, the device including two nozzles 1602 for increasing injection of accelerated fluid from the external power source.

FIG. 17E illustrates a sectional side view of the twin vector amplifier module with a vector thrust ventral flap mechanism providing horizontal thrust.

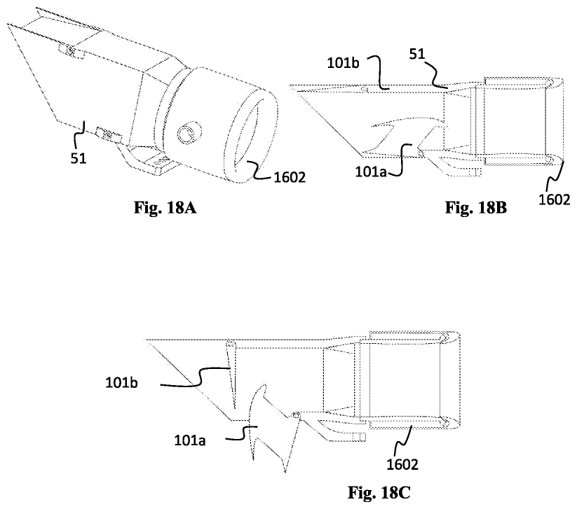

FIG. 18A illustrates a perspective view of a vector amplifier module with external vectoring vector three flap mechanism. In an embodiment, the vector amplifier module includes a nozzle 1602, for injecting fluid from an external power source into the device. The device is bladeless, wherein the power source for accelerating the fluid is placed externally.

FIG. 18B illustrates a sectional side view of the vector amplifier module with external vectoring vector three flap mechanism providing horizontal thrust.

FIG. 18C illustrates a sectional side view of the vector amplifier module with external vectoring vector three flap mechanism providing vertical thrust.

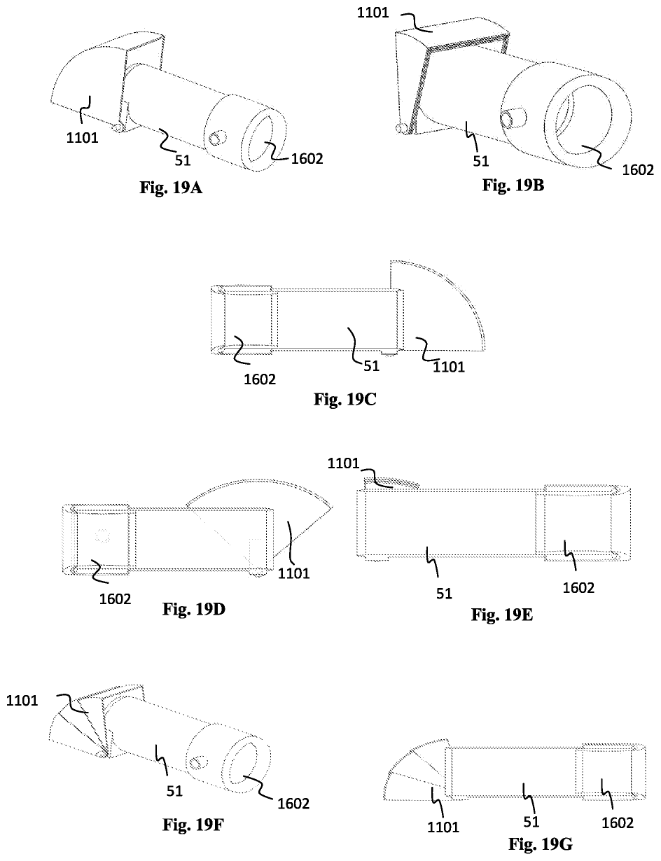

FIG. 19A illustrates a perspective view of a vector amplifier module with a vector thrust bucket mechanism in an expanded position. In an embodiment, the vector amplifier module includes a nozzle 1602, for injecting fluid from an external power source into the device. FIG. 19B illustrates a perspective view of the vector amplifier module with a vector thrust bucket mechanism in a retracted position. FIG. 19C illustrates a side view of the vector amplifier module with a vector thrust bucket mechanism, in an expanded position. FIG. 19D illustrates a side view of a vector amplifier module with a vector thrust foldable bucket mechanism, in a position at an angle. FIG. 19E illustrates a side view of the vector amplifier module with a vector thrust foldable bucket mechanism in a retracted position. FIG. 19F illustrates a perspective view of the vector amplifier module with a vector thrust foldable bucket mechanism in an expanded position. FIG. 19G illustrates a side view of the vector amplifier module with a vector thrust foldable bucket mechanism in an expanded position.

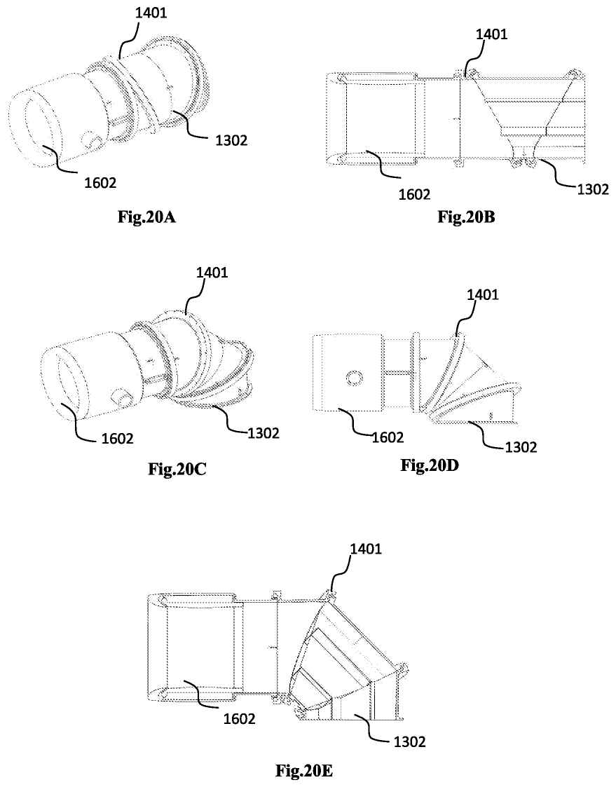

FIG. 20A illustrates a sideview of a vector amplifier module with a vector thrust rotating mechanism providing horizontal thrust. FIG. 20B illustrates a side sectional view of the vector amplifier module with a vector thrust rotating mechanism providing horizontal thrust. FIG. 20C illustrates a perspective view of a vector amplifier module with a vector thrust rotating mechanism providing vertical thrust. FIG. 20D illustrates a side view of the vector amplifier module with a vector thrust rotating mechanism providing vertical thrust. FIG. 20E illustrates a side sectional view of the vector amplifier module with a vector thrust rotating mechanism providing vertical thrust.

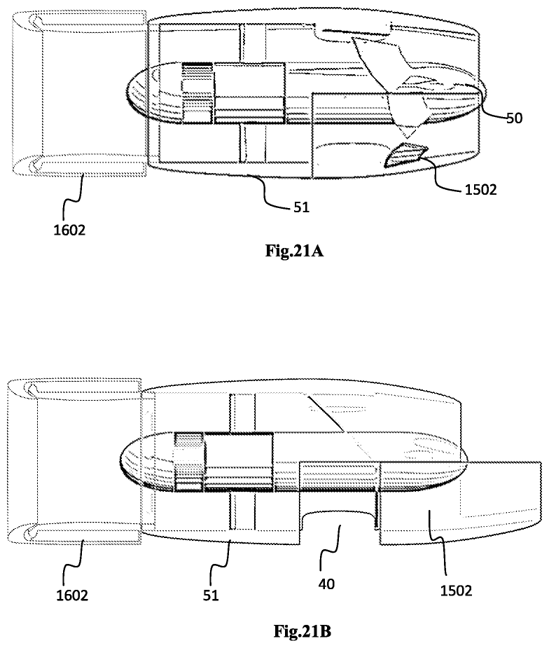

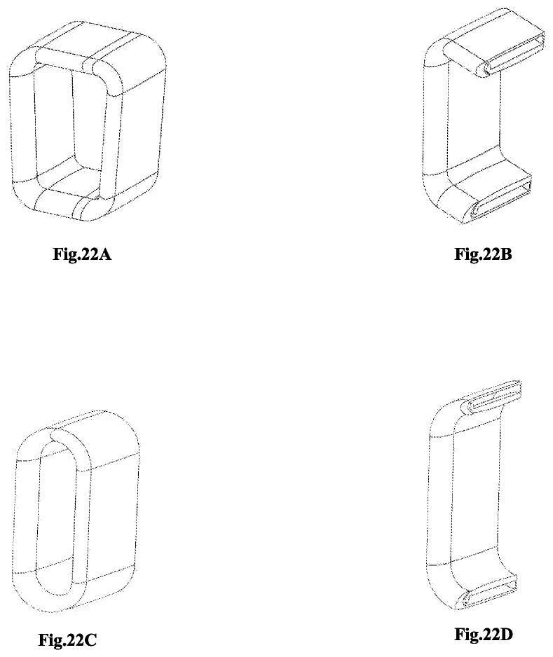

FIG. 21A illustrates a side sectional view of a vector amplifier module with a vector thrust cascade vanes mechanism. FIG. 21B illustrates a side sectional view of the vector amplifier module with a vector thrust cascade vanes mechanism providing vertical thrust. In an embodiment, shape, size and geometry of the nozzle 1602 of the vector amplifier module based on angle of injecting the fluid into the device. The shape including but not limited to asymmetrical oval, oval. FIG. 22A illustrates a perspective view of an asymmetrical shape bladeless thruster geometry of the nozzle 1602 of a vector amplifier module, in an embodiment. FIG. 22B illustrates a perspective sectional view of the asymmetrical shape bladeless thruster geometry of the nozzle 1602 of the vector amplifier module. FIG. 22C illustrates a perspective view of an asymmetrical oval shaped shape bladeless thruster geometry of a nozzle 1602 of a vector amplifier module, according to another embodiment. FIG. 22D illustrates a perspective sectional view of an asymmetrical oval shaped shape bladeless thruster geometry of the nozzle of the vector amplifier module.

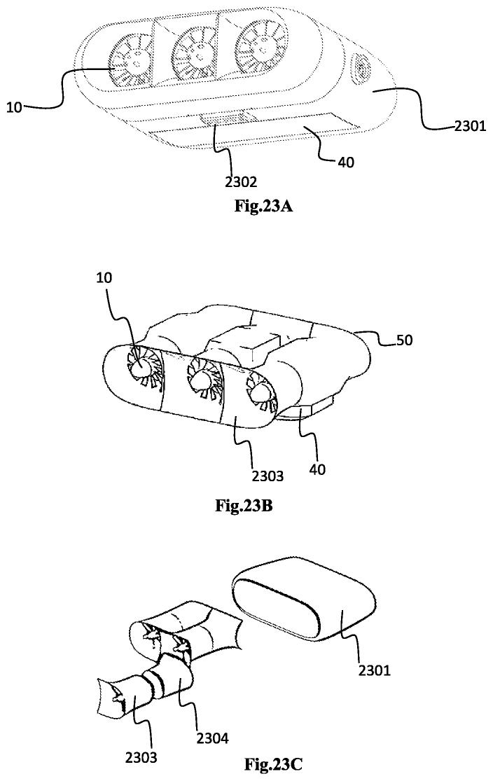

FIG. 23A illustrates a perspective view of a device with plurality of vectored thrust mechanisms. The device includes three vector thrust mechanisms including three ducted fans as the power sources, the vertical exhaust 40, horizontal exhaust, a case 2301 and an attachment fixture 2302 for attaching to the vehicle. FIG. 23B illustrates a perspective view of the device without the case 2301. A power module 2302 houses the power sources 10. FIG. 23C illustrates a perspective view of the device disassembled. In an embodiment, the power module 2303 is operatively connected to an exhaust module 2304. The power module 2302 and the exhaust module 2304 are housed in the case 2301. In an embodiment, the exhaust module 2304 including the vector thrust mechanism, vertical exhaust and the horizontal exhaust.

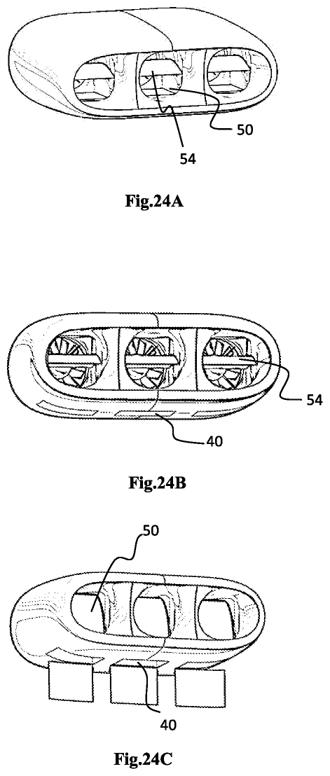

FIG. 24A illustrates a perspective rear view of a device with plurality of vector thrust mechanisms, wherein the vector thrust mechanism is ventral flap mechanism. The ventral flap 54 allowing the fluid through the horizontal exhaust 50 for generating horizontal thrust. FIG. 24B illustrates a lower perspective view of the device providing horizontal thrust, wherein the vertical exhaust 40 is in a closed position. FIG. 24C illustrates a perspective view of the device providing vertical thrust, wherein the horizontal exhaust 50 is closed by the ventral flap 54 and the vertical exhaust in an open position thereby generating vertical thrust.

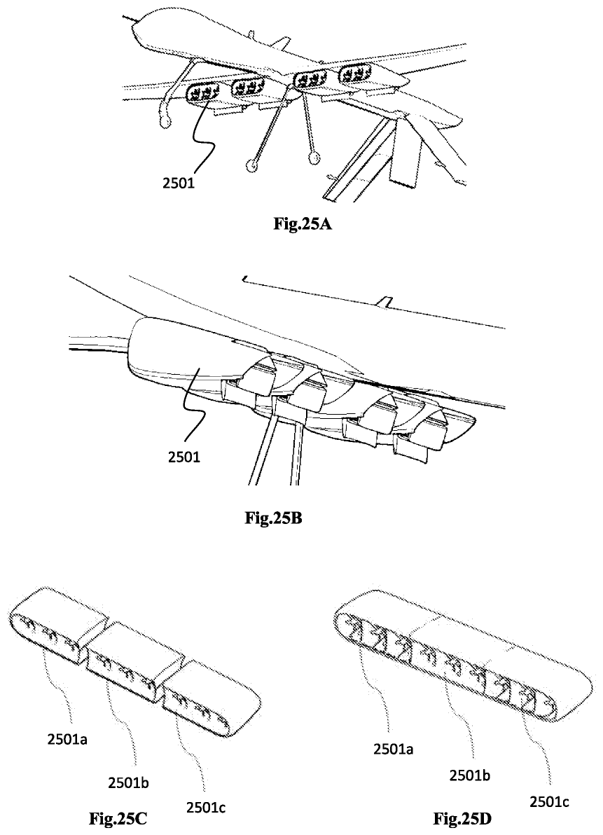

FIG. 25A illustrates a perspective view of a flying vehicle with externally attached plurality of devices 2501 with vector thrust mechanisms. In an embodiment, the vector thrust mechanism is an external vectoring flap mechanism. FIG. 25B illustrates a magnified perspective view of the flying vehicle with the externally attached plurality of devices 2501. FIG. 25C illustrates a perspective view of the devices 2501, including a first set 2501a with three devices for propulsion, a second set 2501b with three devices for propulsion and a third set 2501c with three devices for propulsion. FIG. 25D illustrates a perspective view of the plurality of devices wherein the first set 2501a is attached to the second set 2501b and the second set 2501b is attached to the third set 2501c.

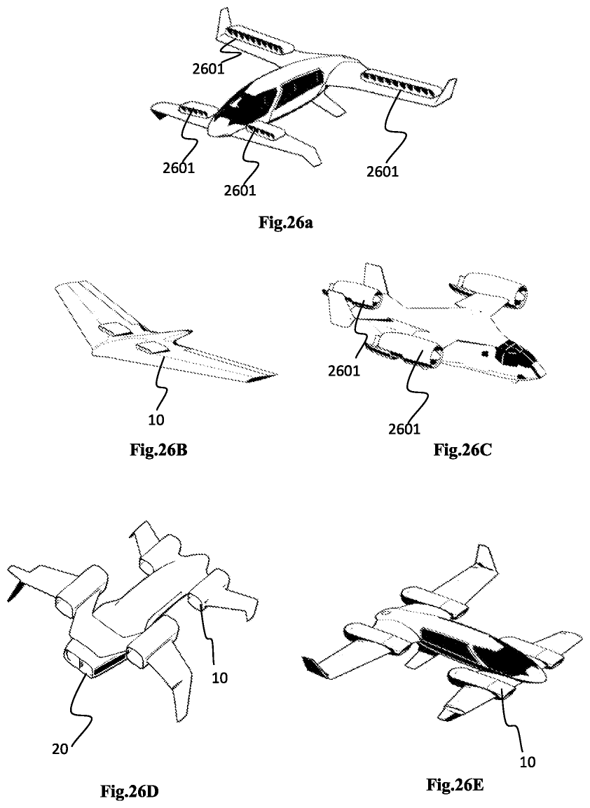

FIG. 26A illustrates a perspective view of a flying vehicle with four-point distribution propulsion systems. Four-point distribution propulsion system includes the devices for propulsion located at both sides of center of gravity of the vehicle. The devices are located at front of the vehicle at both sides, ahead of the center of gravity and at rear of the vehicle at both sides, behind the center of gravity. In an embodiment, the devices are embedded, semi-embedded or externally attached at bottom or above body of the vehicle. An imaginary point of intersection of vertical thrust forces of the devices is equal or nearest to the center of gravity of the vehicle.

FIG. 26B illustrates a perspective view of a flying vehicle with center of gravity distribution propulsion system. The devices are located at each side of the vehicle at front, middle or rear of the vehicle. The devices are embedded, semi-embedded or externally attached at bottom or above the vehicle body along line of center of gravity. The vertical thrust forces of the devices are aligned with line of the center of gravity. An imaginary point of intersection of all the vertical thrust forces is equal or nearest to the center of gravity of the vehicle.

FIG. 26C illustrates a perspective view of a flying with three-point distribution propulsion systems. The devices are located at both left side and right side of the vehicle at a front of the vehicle before the center of gravity or a rear of the vehicle behind the center of gravity and devices are placed at an opposite direction of the pair of devices at a front, middle or rear of the vehicle. An imaginary point of intersection of all the vertical thrust forces is equal or nearest to the center of gravity of the vehicle. The devices are embedded, semi-embedded or externally attached at a bottom or above the vehicle body.

FIG. 26D illustrates a perspective view of a flying vehicle with four-point distribution propulsion system, according to another embodiment.

FIG. 26E illustrates a perspective view of a flying vehicle with mixed distribution propulsion system, according to another embodiment.

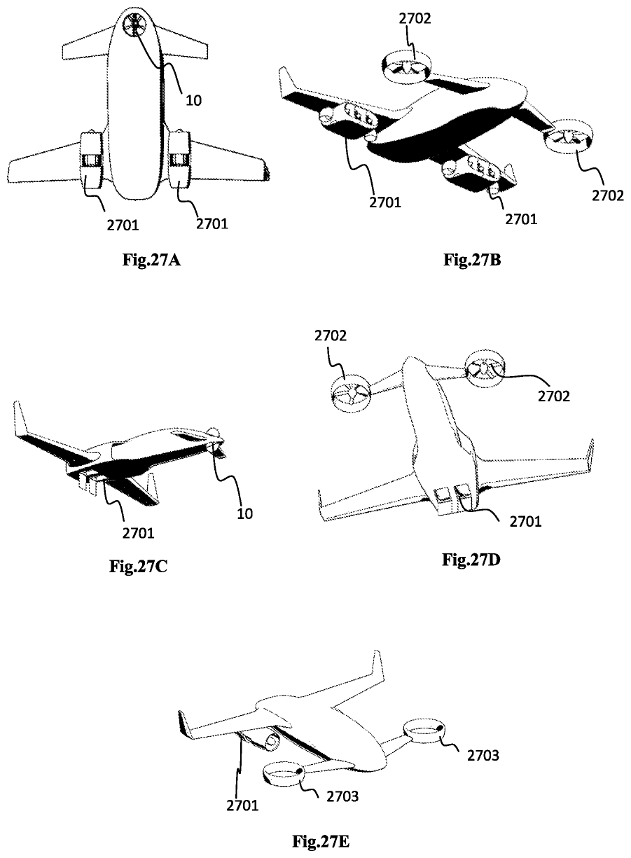

FIG. 27A illustrates a bottom view of a flying vehicle with ducted fan embedded into the nose and rear devices with vectored thrust mechanism. In an embodiment, the device is mixed with propulsion system provided in the vehicle. The flying vehicle includes a ducted fan 10 embedded in nose of the flying vehicle and devices with vector thrust mechanisms 2701 attached at rear of the vehicle to the wings.

FIG. 27B illustrates a perspective view of a flying vehicle with shrouded rotors 2702 attached at front wing tips and devices with vectored thrust mechanism 2701 attached to rear wings.

FIG. 27C illustrates a perspective view of a flying vehicle with a single ducted fan 10 embedded into nose and devices with vectored thrust mechanism 2701 embedded to the fuselage at the rear.

FIG. 27D illustrates a perspective view of a flying vehicle with shrouded rotors 2702 attached at front wing tips and devices with vectored thrust mechanism 2701 embedded to the fuselage at the rear of the vehicle.

FIG. 27E illustrates a perspective view of a flying vehicle with bladeless thruster 2703 attached at front wing tips and devices with vectored thrust mechanism 2701 attached externally to the wing.

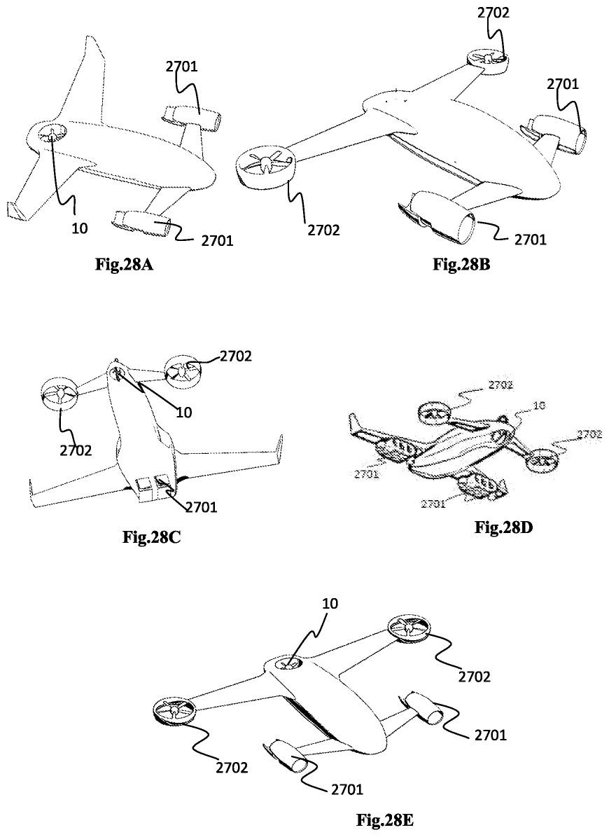

FIG. 28A illustrates a perspective view of a flying vehicle with the ducted fan 10 embedded into rear of the vehicle body and devices with vector thrust mechanism 2701 attached at front wing tips.

FIG. 28B illustrates a perspective view of a flying vehicle with shrouded rotors 2702 attached at rear wing tips and devices with vectored thrust mechanism 2701 attached to front wing tips.

FIG. 28C illustrates a perspective view of a flying vehicle with ducted fan 10 embedded into the nose, shrouded rotors 2702 attached at front wing tips and devices with vectored thrust mechanism 2701 embedded into rear of the vehicle.

FIG. 28D illustrates a perspective view of a flying vehicle with ducted fan 10 embedded into the nose, shrouded rotors 2702 attached at front wing tips and devices with vectored thrust mechanism 2701 externally attached to rear of the vehicle.

FIG. 28E illustrates a perspective view of a flying vehicle with ducted fan 10 embedded into the rear of the body, shrouded rotors 2702 attached at rear wing tips and devices with vectored thrust mechanism 2701 externally attached at front wing tips.

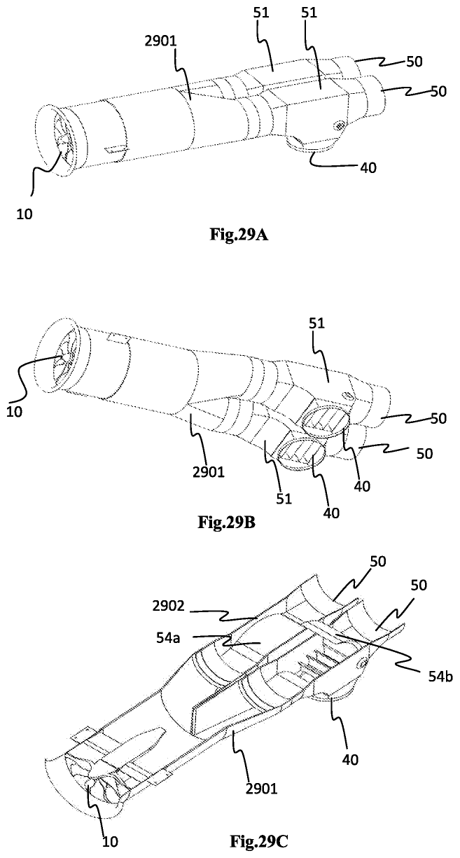

FIG. 29A illustrates an upper perspective view of a device without case with the power source and two vector thrust ventral flap mechanism exhaust modules. The device including a geometry 2901 integrating the power source 10 with the exhaust module duct 51 including the vertical exhaust 40 and the horizontal exhausts 40. FIG. 29B illustrates a lower perspective view of the device. FIG. 29C illustrates a perspective sectional view of the device. In an embodiment, a ventral flap 54a is in a position directing the fluid to the horizontal exhaust generating horizontal thrust and a ventral flap 54b is in a position directing the fluid to the vertical exhaust generating vertical thrust.

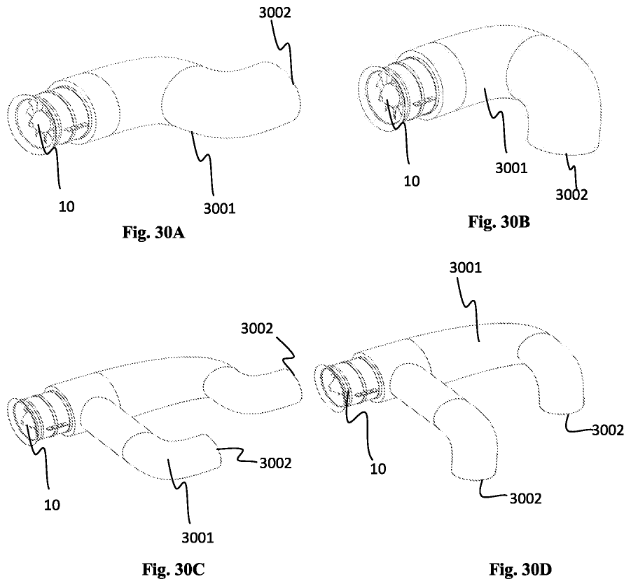

FIG. 30A illustrates a perspective sectional view of a device without case with a power source and a swivel elbow mechanism exhaust module in horizontal flight position. In an embodiment, the device including a ducted fan as the power source 10 accelerating fluid into an exhaust module 3001 including a swivel elbow exhaust 3002 for letting out the fluid horizontally and generating horizontal thrust. In an embodiment, the swivel elbow exhaust 3002 is rotatable relative to the device at an angle ranging from 0 degrees to 360 degrees for redirecting the working fluid to the predetermined direction and generating thrust in the predetermined direction. The swivel elbow exhaust rotating independent of the power source and connected to a rotating mechanism including but not limited to servo motor, electric motor and actuator. FIG. 30B illustrates a perspective sectional view of a device without case with a power source and a swivel elbow mechanism exhaust module in vertical flight position. In an embodiment, the device including a ducted fan as the power source 10 accelerating fluid into the exhaust module 3001 through the swivel elbow exhaust 3002 for letting out the fluid vertically and generating vertical thrust.

FIG. 30C illustrates a perspective sectional view of a device without case with a power source and double swivel elbow mechanism exhaust module in horizontal flight position. In an embodiment, the device including two swivel elbow exhausts 3002 for generating additional thrust. FIG. 30D illustrates a perspective sectional view of a device without case with a power source and double swivel elbow mechanism exhaust module in vertical flight position.

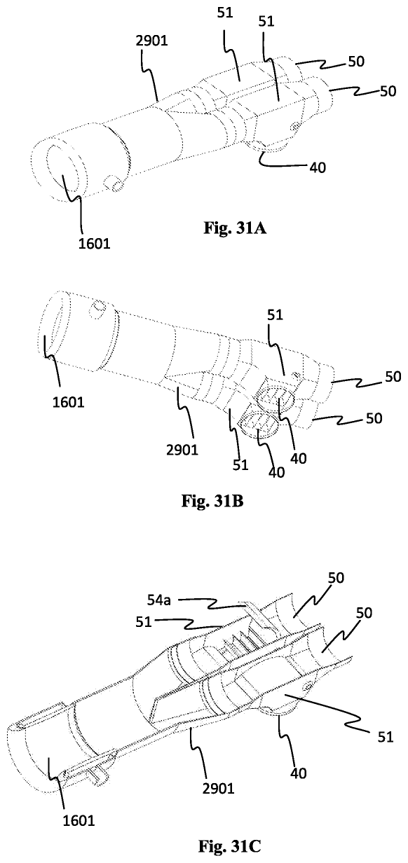

FIG. 31A illustrates an upper perspective view of a vector amplifier module without case with two integrated vector thrust ventral flap mechanism. In an embodiment, the vector amplifier module including nozzle 1602 and two vector thrust mechanisms with two horizontal exhausts 50 integrated with the nozzle 1602. FIG. 31B illustrates a lower perspective view of the vector amplifier module without case with two integrated vector thrust ventral flap mechanism. FIG. 31C illustrates a perspective sectional view of the vector amplifier module without case with two integrated vector thrust ventral flap mechanism.

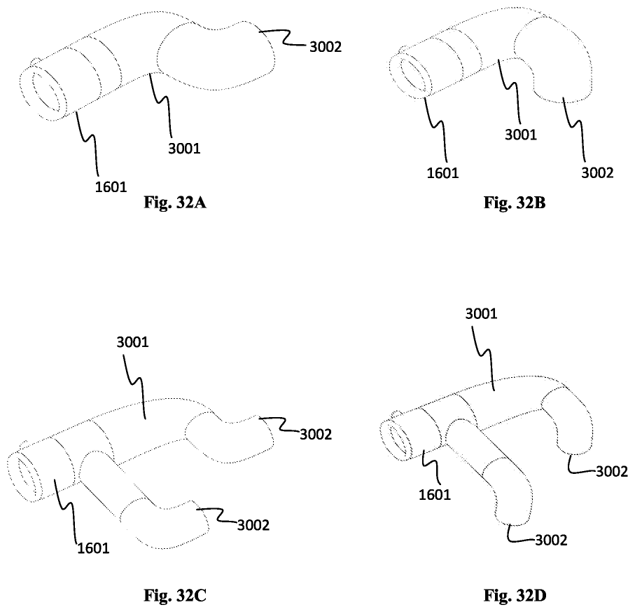

FIG. 32A illustrates a perspective sectional view of a vector amplifier module without case with integrated single swivel elbow mechanism in horizontal flight position. In an embodiment, the vector amplifier module including the nozzle 1602 for injecting fluid into the device from an external power source. FIG. 32B illustrates a perspective sectional view of the vector amplifier module without case with integrated single swivel elbow mechanism in vertical flight position.

FIG. 32C illustrates a perspective sectional view of a vector amplifier module without case with integrated double swivel elbow mechanism in horizontal flight position. In an embodiment, the vector amplifier module including the nozzle 1602 for injecting fluid into the device from an external power source. FIG. 32D illustrates a perspective sectional view of a vector amplifier module without case with integrated double swivel elbow mechanism in vertical flight position.

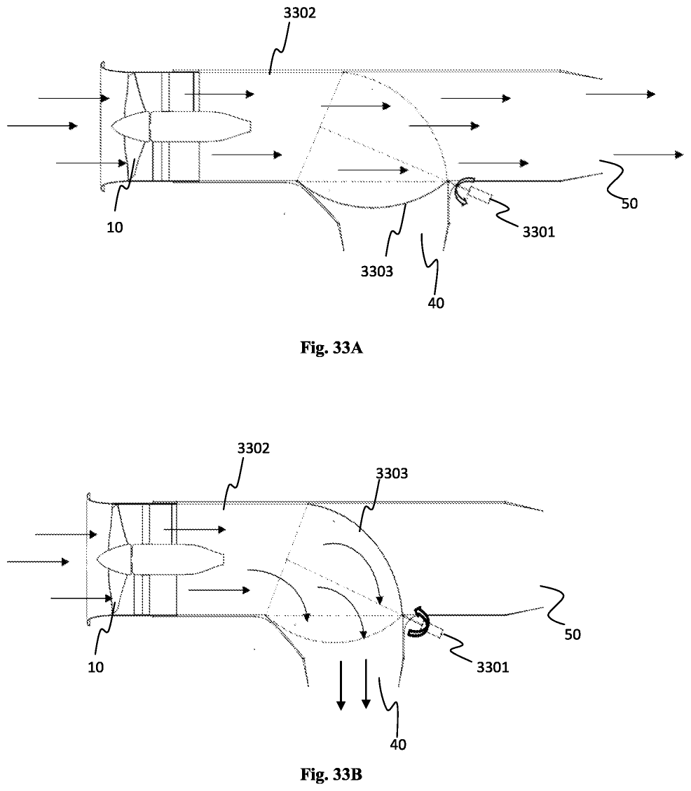

FIG. 33A illustrates a sectional side view scheme of a device with a power source and a vector thrust ventral rotating mechanism providing horizontal thrust. In an embodiment, the device including a servo motor with a shaft 3301 for rotating a ventral curved surface 3303 to redirect the fluid through the horizontal exhaust 50 or the vertical exhaust 40. The device including a middle duct geometry 3302 for allowing the fluid from the power source 10 to the vector thrust mechanism including the ventral curved surface 3303. The ventral curved surface 3303 redirecting fluid to the horizontal exhaust 50 thereby generating horizontal thrust. FIG. 33B illustrates a sectional side view scheme of the device with a power source and a vector thrust ventral rotating mechanism providing vertical thrust. The ventral curved surface 3303 redirecting fluid to the vertical exhaust 50 thereby generating vertical thrust.

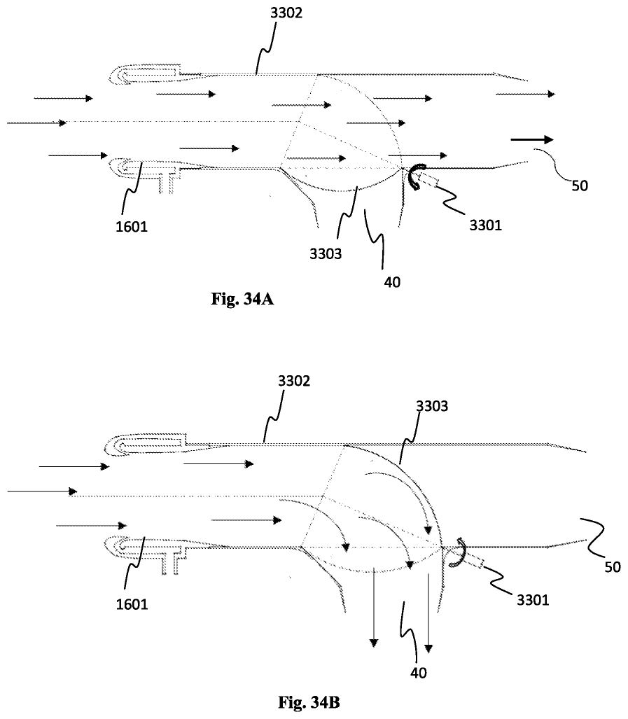

FIG. 34A illustrates a sectional side view scheme of a vector amplifier module without case with a vector thrust ventral rotating mechanism providing horizontal thrust. The vector amplifier module including the nozzle 1601 for injecting fluid from an external power source. The ventral curved surface 3303 redirecting fluid to the horizontal exhaust 50 thereby generating horizontal thrust. FIG. 34B illustrates a sectional side view scheme of the vector amplifier module without case with a vector thrust ventral rotating mechanism providing vertical thrust. The ventral curved surface 3303 redirecting fluid to the vertical exhaust 50 thereby generating vertical thrust.

A main advantage of the present disclosure is that the device for propulsion provides VTOL/STOL capabilities to the vehicle.

Another advantage of the present disclosure is that the device for propulsion is attachable and detachable to the vehicle.

Still another advantage of the present disclosure is that the device including components of power module, exhaust module and vector thrust mechanism, wherein the components are removably attached to the device and capable of being swapped, exchanged and removed during maintenance.

Yet another advantage of the present disclosure is that the device for propulsion capable of being customized based on amount of thrust required, shape and size of the vehicle.

Still another advantage of the present disclosure is that the device including combinations of power module, exhaust module and vector thrust mechanism for generating desired thrust and maneuvering of the vehicle.

Yet another advantage of the present disclosure is that the device for propulsion being cost-effective and economical due to ease of maintenance through detachable and replaceable components.

Still another advantage of the present disclosure is that the device providing propulsion with better efficiency, minimum power loss and without generation of significant turbulence on the fluid through the vector thrust mechanism.

Still another advantage of the present disclosure is that the device for propulsion provides a simpler design for ease of usage with a vehicle.

Yet another advantage of the present disclosure is that the device for propulsion is capable of being combined with existing propulsion system in a vehicle for providing additional maneuvering capabilities.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

I claim:

1. A device for propulsion in a vehicle, comprising:
an inlet for allowing a fluid;
a power module provided for accelerating the fluid;
a vector thrust mechanism fluidly connected to the power module for redirecting the accelerated fluid to a predetermined angle; and
the vector thrust mechanism redirecting the fluid towards an exhaust provided at a predetermined direction for generating the thrust in the predetermined direction to maneuver the vehicle.

2. The device as claimed in claim 1, wherein an exhaust module fluidly connected to the vector thrust mechanism for letting out the fluid; and
the exhaust module including a plurality of exhausts provided in a plurality of directions for generating the thrust in the predetermined direction.

3. The device as claimed in claim 1, wherein the vector thrust mechanism providing vertical takeoff and landing capability and short takeoff and landing capability to the vehicle.

4. The device as claimed in claim 1, wherein the vector thrust mechanism including a ventral flap; and
the ventral flap rotating for opening and closing the exhaust of the device for generating the thrust in the direction of the open exhaust.

5. The device as claimed in claim 4, wherein the vector thrust mechanism including turning vanes for correcting direction of the fluid for flowing through the exhaust.

6. The device as claimed in claim 4, wherein a geometry of the ventral flap reducing loss of thrust and turbulence of the fluid; and
the geometry preventing leakage of the fluid to the closed exhaust.

7. The device as claimed in claim 4, wherein the ventral flap adapted to geometry of the vehicle for contributing to lift production of a wing of the vehicle.

8. The device as claimed in claim 4, wherein the ventral flap rotating about a shaft and connected to a rotating mechanism selected from a group consisting of servo motor, actuator and electric motor.

9. The device as claimed in claim 1, wherein the vector thrust mechanism including an external vectoring flap mechanism for redirecting the accelerated fluid;
the external vectoring flap mechanism including plurality of ventral flaps rotatable for opening and closing the exhaust and redirecting the fluid to the predetermined direction for generating the thrust.

10. The device as claimed in claim 9, wherein the rotation of the ventral flaps synchronized for opening an exhaust and closing another exhaust.

11. The device as claimed in claim 9, wherein a rotating mechanism rotating the ventral flaps; and
the rotating mechanism selected from a group consisting of servo motor, actuator and electric motor.

12. The device as claimed in claim 1, wherein the vector thrust mechanism including a bucket mechanism for redirecting the accelerated fluid; and
the bucket mechanism including a curved surface retracting and expanding about an angle relative to a point of contact to the device for redirecting the fluid to the predetermined direction.

13. The device as claimed in claim 12, wherein a rotating mechanism rotating the curved surface; and
the rotating mechanism selected from a group consisting of servo motor, actuator and electric motor.

14. The device as claimed in claim 12, wherein the curved surface including plurality of segments for reducing occupation of space in the device; and
the segments foldable during retraction and expanded during expansion of the curved surface.

15. The device as claimed in claim 1, wherein multi exhaust modules with independent vector thrust mechanism is used including a multi directional duct for redirecting the accelerated fluid from the power module;

16. The device as claimed in claim 1, wherein multi power modules are attached to only one exhaust module with vector thrust mechanism including a multi directional duct for redirecting to the exhaust module;

17. The device as claimed in claim 1, wherein the vector thrust mechanism including a cascade vanes mechanism for redirecting the accelerated fluid; and
the cascade vanes mechanism including a plurality of spaced segments formed on a surface of the device, wherein the spaced segments movable relative to the device for opening and closing the exhausts.

18. The device as claimed in claim 17, wherein a secondary mechanism connected to the spaced segments for opening and closing the exhausts on surface of the device.

19. The device as claimed in claim 17, wherein the segments are aligned through a frame ring provided as pivot for rotating the segments thereby opening and closing a horizontal exhaust of the device.

20. The device as claimed in claim 19, wherein the segments and the secondary mechanism connected to a mechanism selected from a group consisting of servo motor, actuator and link for automated movement.

21. The device as claimed in claim 1, wherein the vector thrust mechanism including a rotating mechanism including a swivel elbow exhaust for redirecting the accelerated fluid;
Wherein the swivel elbow exhaust operatively connected to the power module through an exhaust duct for receiving the accelerated fluid; and
The swivel elbow exhaust rotatable relative to the power module about an angle ranging from 0 degrees to 360 degrees for redirecting the accelerated fluid.

22. The device as claimed in claim 1, wherein the vector thrust mechanism including a ventral curved surface rotatable by rotary servo and a shaft for opening and closing the exhaust and redirecting the fluid; and
the ventral curved surface redirecting the fluid to the predetermined direction with reduced turbulence.

23. The device as claimed in claim 1, wherein a case provided for housing the power module, the vector thrust mechanism and the exhausts; and
the case facilitating attachment and detachment of the device to the vehicle.

24. The device as claimed in claim 1, wherein the power module, the exhaust and the vector thrust mechanism integrated forming a vector amplifier module.

25. The device as claimed in claim 24, wherein the vector amplifier module injecting the fluid into the device from a power source provided externally thereby the device being bladeless.

26. The device as claimed in claim 24, wherein the vector amplifier module including a nozzle for injecting the fluid into the device received from an external power source and accelerating the fluid through COANDA effect; and
redirecting the accelerated fluid through the vector thrust mechanism for generating the thrust.

27. The device as claimed in claim 1, wherein the device provided in the vehicle by means selected from a group consisting of externally attached to the vehicle, attached to wing of the vehicle, embedded into the vehicle, embedded into wing of the vehicle, semi-embedded into the vehicle, and semi-embedded into wing of the vehicle.

28. The device as claimed in claim 1, wherein the device including plurality of vector thrust mechanisms and plurality of power sources for generating thrust in the predetermined directions; and
the vector thrust mechanism and the power sources combined based on the thrust required for the vehicle.

29. The device as claimed in claim 1, wherein the device removably attached to the vehicle; and
the power source and the vector thrust mechanism removably attached to the device.

30. The device as claimed in claim 1, wherein the power module fluidly connected to a power source selected from a group consisting of ducted fan, centrifugal fan, axial fan and jet engine.

31. The device as claimed in claim 1, wherein the device combined with a propulsion system provided in the vehicle for generating additional thrust.

32. The device as claimed in claim 2, wherein an exhaust module duct provided for housing the vector thrust mechanism and the exhaust module; and
a cross-sectional shape of the exhaust module duct reducing turbulence of the accelerated fluid.

33. The device as claimed in claim 1, wherein the predetermined direction including vertical and horizontal for generating thrust in vertical direction and horizontal direction.

34. The device as claimed in claim 2, wherein the exhaust including a vertical exhaust provided for letting the fluid through vertical direction thereby generating vertical exhaust and a horizontal exhaust provided for letting the fluid through horizontal direction thereby generating horizontal exhaust.

35. The device as claimed in claim 1, wherein the vector thrust mechanism movable relative to the device for redirecting the fluid;
the vector thrust mechanism connected to a mechanism for automating the movement; and
the mechanism selected from a group consisting of servo motor, electric motor, non-electric motor, actuator and mechanical linkage.

36. The device as claimed in claim 1, wherein the predetermined angle ranging from 0 degrees to 360 degrees.

37. The device as claimed in claim 1, wherein a plurality of devices combined with another different kind of propulsion system provided in the vehicle with a center of gravity, three-point, four-point, or mixed distribution to generating thrust.

38. The device as claimed in claim 24, wherein the vector thrust mechanism including a ventral flap; and
the ventral flap rotating for opening and closing the exhaust of the device for generating the thrust in the direction of the open exhaust.

39. The device as claimed in claim 24, wherein the vector thrust mechanism including an external vectoring flap mechanism for redirecting the accelerated fluid;
the external vectoring flap mechanism including plurality of ventral flaps rotatable for opening and closing the exhaust and redirecting the fluid to the predetermined direction for generating the thrust.

40. The device as claimed in claim 24, wherein the vector thrust mechanism including a bucket mechanism for redirecting the accelerated fluid; and
the bucket mechanism including a curved surface retracting and expanding about an angle relative to a point of contact to the device for redirecting the fluid to the predetermined direction.

41. The device as claimed in claim 24, wherein the vector amplifier has multiple geometry for fluid injection from different power sources and one multi directional duct for redirecting the accelerated fluid to unique vector thrust mechanism;

42. The device as claimed in claim 24, wherein the vector amplifier has a multi directional duct for redirecting the accelerated fluid to multiple and independent vector thrust mechanism;

43. The device as claimed in claim 24, wherein the vector thrust mechanism including a cascade vanes mechanism for redirecting the accelerated fluid; and
the cascade vanes mechanism including a plurality of spaced segments formed on a surface of the device, wherein the spaced segments movable relative to the device for opening and closing the exhausts.

44. The device as claimed in claim 24, wherein the vector thrust mechanism including a rotating mechanism including a swivel elbow exhaust for redirecting the accelerated fluid;
Wherein the swivel elbow exhaust operatively connected to the power module through an exhaust duct for receiving the accelerated fluid; and
The swivel elbow exhaust rotatable relative to the power module about an angle ranging from 0 degrees to 360 degrees for redirecting the accelerated fluid.

45. The device as claimed in claim 24, wherein the vector thrust mechanism including a ventral curved surface rotatable by rotary servo and a shaft for opening and closing the exhaust and redirecting the fluid; and
the ventral curved surface redirecting the fluid to the predetermined direction with reduced turbulence.
